(19) United States
(12) Patent Application Publication
(10) Pub. No.: US 2022/0232757 A1
(43) Pub. Date: Jul. 28, 2022

(54) Systems And Methods For Improved Horticulture Donor Tray Efficiency To Optimize Order Fulfillment

(71) Applicant: Tagawa Greenhouse Enterprises, LLC, Brighton, CO (US)

(72) Inventor: Randall E. Tagawa, Broomfield, CO (US)

(21) Appl. No.: 17/586,411

(22) Filed: Jan. 27, 2022

Related U.S. Application Data
(60) Provisional application No. 63/142,338, filed on Jan. 27, 2021.

(51) Int. Cl. A01C 11/02; A01G 9/08; G06Q 10/08; G06Q 10/06

(52) U.S. Cl. CPC A01C 11/025; G06Q 10/06315; G06Q 10/087; A01G 9/086

(57) ABSTRACT

Automated, metrically controlled methods and systems of cultivating plants to maximize customer order fulfillment can dynamically take into consideration growing conditions and environments of transplant propagules, plants, and seedlings and even changeable order requirements. Through an appropriately configured programmable plant growth configured computer system, computer logic determined optimization of transplanting times, growth conditions, planting needs, and transplant propagule quantities, among other aspects, may be met more efficiently, with less waste at closer to one hundred percent. Programmable plant growth configured computer systems may be configured with a multi-cycle replacement tray maximization metric programs, and/or a multi growth stage parameterized metrics to achieve processes that are mare than just automated, but are fundamentally more than and different from previous systems. Automatic metric controls can simultaneously and differentially control donor tray growth environments apart from customer tray environments as automatically provided for by a program implemented to utilize multi-cycle replacement tray or multi growth stage parameterized metrics to sequence and achieve outcomes not previously available. Optimization of transplanting to customer plant trays and use and disposal of donor trays may optimize the economics by reducing waste through new processes that are fundamentally different and dynamically adaptable in real time from those manually conducted. Through transplanting optimization customer yields and producer efficiencies may be maximized.

This application claims priority to, and the benefit of, U.S. Provisional App. No. 63/142,338, filed Jan. 27, 2021, said application hereby incorporated in its entirety herein by reference.

### FIELD OF THE INVENTION

Generally, this invention relates to systems and methods for periodically and perhaps regularly providing wholesale plants for sale to retailer consumers. More specifically, this invention relates to improving and optimizing the efficiency of donor tray systems and methods.

### BACKGROUND OF THE INVENTION

In today's growing market for pre-grown plants, consumers have varying demands that are required to be met from the nurseries and grow operations supplying the plants. In order to meet customer demands, suppliers may plant an extra tray of plants to grow alongside the customer order so that sub-par plants may be replaced and the customer provided a full, thriving order of plants. The plants are ordinally grown in trays for ease of transport. Retail customers have a wide variety of needs including but not limited to demanding varying species of plant per order, varying numbers of plants per weekly order, and varying sizes of plants needed for each order. Customers may have varying tray sizes as well, some as low as 36 cells up to 512, but not limited to only these sizes. This can create a problem for growers on how to meet the varying demands of consumers while maintaining a cost-effective and efficient grow operation. For further efficiencies, to meet customer demands, the supplier may utilize a plant punch machine or other automated transplanting equipment when transplanting the plants grown, such as from the extra tray to the customer's tray.

One issue that may arise during the growing cycle is that during or before the transplant event, the propagules may become damaged or unusable due to a variety of factors (e.g., death of the propagules, disease in the tray, damage due to transplanting event, etc.). Yield maximization may be completed by utilizing systems such as those described in U.S. Pat. Nos. 7,069,693 and 6,779,300. To meet 100 percent order fulfillment or the like, an extra tray called a donor tray may be sown. Most varieties may have an approximately 80 to 90 percent germination rate; some varieties may be above or below this percentage. This may require donor plants to fill the approximately 10 to 20 percent loss in the customer tray. In a customer tray with 300 cells at a 90 percent germination rate, an extra 30 plants per week would need to be planted to meet a customer's weekly order. These replacement plantings can be most efficiently incorporated through the use of a plant punch machine transplant lug system, such as described in U.S. Pat. Nos. 6,915,607 and 7,984,583 as examples. Once the weekly order is filled, the remaining plants in the donor tray may sometimes be discarded, and a new tray may sometimes be planted for a subsequent order, such as to synchronize growth stages or such. This process may be repeated and can lead to a large waste of plants and planting time. The present invention aims to solve the waste problem while also increasing efficiency and cost savings, especially when used in conjunction with plant punch machine transplanting.

Importantly, planting a separate donor tray each week to meet 100 percent order fulfillment can be highly inefficient and wasteful because the remaining donor plants of the donor tray can be, and are, sometimes discarded at the end of each week and a new donor tray planted for some subsequent week's orders. The goal to increase the efficiency of overall operations, especially for donor tray transplanting systems, is not adequately met with current systems. To increase efficiency, which may in turn, reduce waste, there may be a specific process based on root ball size, time of plants in cold storage, time of growth, and the like, that allows a grower to optimize its system and processes.

Each of these potential aspects may be addressed by known methods, but these may cause a reduction in, or at least non-optimal: operational and production efficiency, higher production costs, and an overall decrease in greenhouse output and ability to meet consumer demand, as but a few examples. The inventive technology disclosed seeks to alleviate or eliminate some or all of these problems, among others.

### SUMMARY OF THE INVENTION

In general, the present invention involves both devices and methods in a variety of embodiments to achieve improved horticulture fulfillment, supply, or donor tray efficiency, especially when used in conjunction with plant punch machine transplanting and/or other automated transplanting equipment. Other automated transplanting equipment may be but is not limited to robotic transplanting arms, automated claw type removal devices, or other automated-smart transplanting equipment. The present invention may be utilized by any technology that utilizes automation to improve planting efficiencies. It may optimally involve utilizing a programmable plant growth configured computer system and configured programmable logic in ways that do not merely automate other perhaps manual operations, do not just make known operations more efficient, but that are a key to fundamentally changing how donor utilization is conducted and that offer previously out of reach efficiencies not in existing activities but in the entire horticultural donor process. These embodiments can provide more than just speed (indeed speed of actions is not even an issue focused upon), more than just automation. As explained in the following, they provide something more and they even approach the donor component of operations very differently. Embodiments of the present invention include several aspects that may be beneficial to cultivators of plants and to cultivating activities and methods. The present invention may involve or result in less waste of plants and of donor trays in the cultivation of wholesale plant production. In some embodiments, high cell density donor trays with specific transplant processes may be used in ways that allow for higher production efficiencies and, among other aspects, even storing larger quantities of donor plants for transplanting to a customer tray or growth tray. As but one example, by utilizing high cell density donor trays in different ways that offer something more than just the known, usually manual processes, with such specific transplant processes, it can now be more efficient to produce plants and perhaps store plants, which may lead to larger production volumes, more optimal efficiencies, better costs, and/or even a higher percentage of periodic order fulfillment. As to this one component, the high cell density, or other donor trays with the indicated processes may also help to improve order fulfillment because by improving spatial constraints such as can exist for same cell size donor trays (equal cell density between donor tray and customer tray) or for existing amount of donor propagules, higher cell density donor trays and the processes disclosed can be sown and may be used to improve order fulfillment each week, even with variable yields. Weekly order fulfillment of 100 percent may be required by some customers; some embodiments of the present invention may allow this to be done more efficiently through utilizing efficient systems and methodologies, such as but not limited to, processes that are more efficient, donor tray elements that are more efficient, high cell density donor trays and, among other aspects, even metrically controlled processes for donating or replacing a donor plant.

In some embodiments, processes can be conducted metrically with the use of a programmable plant growth configured computer system or logic. In other embodiments, the donor tray may be a different size tray that may be conducive to having a higher density of cells in the tray and may have the ability to transplant the plants into the original customer tray even for imminent sale. In some instances, there may be, for example, a two-week gap between donor tray planting and transplanting into a customer tray. In some embodiments, this may be achieved by placing the particular or improved donor tray under metrically determined environments, perhaps such as under cold storage to slow the growth rate to match up with future trays sown at later dates all as metrically determined. The higher density tray may allow more plants to be sown in a single tray but it may also be sized to only what is needed and may be grown in a quantitatively determined and indicated manner to minimize waste. Of course, utilizing a donor tray with more plants may improve efficiencies by allowing more donor propagules to be available, but the processes now achieved add something more and make the production and order fulfillment more efficient. Plants may be transplanted into the other trays while the plants are young, usually, but not limited to, two to eight weeks before the trays are shipped to customers (and in some instances in order to allow the donor plants to grow with the other customer plants to blend in and perform without unacceptably large variances between plants). In some embodiments, after an appropriate donor tray is used the first week, the tray may be stored under computer indicated are perhaps determined lighting and conditions such as cold storage or the like to synchronize and likely reduce the growth rate of the plants while maintaining a healthy plant for transplant. Possibly each week for some period, the same donor tray can be utilized to fill the cells, with no additional plantings or more replacement plants, until the donor tray is empty or nearly so. In some embodiments, more donor trays can be sown to help improve order fulfillment each week with varying customer demands and these multiples can even be calculationally coordinated with other donor trays and even adapted to be coordinated in real time. In other embodiments, to avoid inefficiencies and inefficient discards such as discard of donor trays after each week or sub-optimally, such as due to storage constraints and germination age, higher cell density trays can be linked with fundamentally new processes that may be used for multiple weeks, which may lead to less waste of donor trays and cost savings, among other possible advantages. The higher cell density donor trays may also allow for storing a larger quantity of donor plants and the processes may allow these to be metrically coordinated. The higher cell density donor tray with the various processes may increase efficiency, possibly due to the ability to store donor plants, and can combine to allow weekly 100 percent order fulfillment to be met with new efficiencies. In other embodiments, donor tray usage, plant replacement timing, and donor tray waste can be more appropriately and perhaps even metrically controlled for optimal results.

In some embodiments, plants may be sown through methods such as planting a seed, or in other embodiments, it may be beneficial to utilize unrooted cuttings taken from other plants that are sown into soil or other substrates and allowed to grow roots or to sow other viable plants. Viable plants may be plants that, after seed germination, after unrooted cuttings rooted, or after plants grown to size in a particular size tray or pot are ready for transplanting, sale, or order fulfillment.

In some embodiments, metrically controlled processes may be based on, but are not limited to, replacement timing growth curves between donor tray and customer tray; growing conditions, such as but not limited to, humidity, soil type, feedwater flow rate, and time under light; the size of donor root ball compared to customer plant root ball size; the cost of donor tray compared to cost of donor waste; metrics of using a plant punch machine transplant system; or a complex ratio between donor plant and customer plant. As persons of ordinary skill in this field would well understand, these can be worked out generally or even adapted to specific plant type or supply paradigms.

In one embodiment of an optimally efficient donor process, a metric for when and how replacement of customer tray plants should or may occur may be modeled through replacement timing and differential metric control of environmental conditions. Some replacement timing may take into account when SIZE_{customer}≈SIZE_{donor} to trigger donation or transplant. Another may utilize concepts such as comparing Customer supply, perhaps C, and Donor plant, perhaps D, and creating metrics where Cₜᵢₘₑ, C_{size}, and/or C_{viability}≈D_{warmtime}+D_{coldtime} to trigger replacement. As but one example of an embodiment, to trigger replacement, the time the customer plant spends growing (Cₜᵢₘₑ) may equal or be substantially near the time the donor plant spends in warm or ambient conditions (D_{warmtime}) plus, or apart from, the time the donor plant spends in cold storage (D_{coldtime}). In another embodiment, to trigger donation the size of the customer pant (C_{size}) may equal one or more growth constants (G_{customer} or G_{donor} or G_{donor-warm} or G_{donor-cold}) times the time the donor plant spends in warm or ambient conditions (D_{warmtime}) plus, or apart from, the time the donor plant spends in cold storage (D_{coldtime}). In yet another embodiment, to trigger replacement, the viability of the customer plant (C_{viability}) may equal one or more viability constants (V_{customer} or V_{donor} or V_{donor-warm} or V_{donor-cold}) times the time the donor plant spends in warm or ambient conditions (D_{warmtime}) plus the time the donor plant spends in cold storage (D_{coldtime}) ore the like.

Further, in some embodiments, these metrics may be combined and may even involve complex equations of higher-order polynomials or that are derivative-based, in order to, but not limited to utilize rate of change of these metrics. In some embodiments, the donor plants may still be growing under storage conditions at a slower rate than plants that are not in storage. A metric for replacing dead or damaged plants may optimize the efficiency of donating from a donor tray. In another embodiment, an efficient transplanting system may utilize a system or process that may use a metrically controlled replacement timer or worker guidance display/program. These may even involve empirically derived values, prior propagule growth information, a look-up table reference, or even subjective daily or weekly grower plant condition entries. A replacement timer may be a combination of growth curves and computer or operator-controlled methods. A replacement timer growth curve may track the size of the customer plant, the size of a donor plant, the customer plant time spent growing and set this equal to the donor time spent growing under ambient plus, or apart from, donor time spent growing under cold conditions operated on by one or more constants to allow the most optimized donor transplanting and/or most optimized production economics. The constants or variables may be some value such as time, a specific number based on industry practice, or a number averaged from operator knowledge.

In some embodiments, it may be efficient to replace damaged or dead customer tray plants or propagules with donor tray plants or propagules that have a smaller root ball. In some embodiments, the customer tray may have a cell that may be but is not limited to two to four times the size of the customer plant's root ball to allow for continued growth. For efficient growing and storage of donor plants, donor plants may be grown in cells that may be, but not limited to, similar or two times larger than the donor plant root ball. For efficiency, the small root ball donor plants may be limited in growth until they are transplanted into large root ball volume customer tray cells, at a time when the donor plant and the customer plant are equal to similar in size. Again, metrics can be easily developed for such considerations and this may be computer implemented with dynamic real time determinations and go beyond and are something more than mere automation of known manual processes.

In another embodiment, it may be most efficient to discard a donor tray rather than to continue to use one. This decision may be made based on a number of factors and even metrics, including but not limited to cost of storage, donor plant viability, and donor plant age. Such systems or processes may utilize economic curves to determine when the cost of keeping a multi-cycle donor tray outweighs the cost of planting a new donor tray and can be displayed to guide workers appropriately or automatically implemented.

In some embodiments, for optimized transplanting efficiency, the donor plant may be different than the customer plant in some way, such as having a different size root ball, being at a different growth stage, or having an uneven growth distribution as compared to that of a customer plant. And this can be controlled to be within customer acceptances by metrics.

In other embodiments, there may be a series of metrics and algorithms that control the process. This process may be optimized to enable a plant retailer to efficiently meet customer production demands by using predetermined or simultaneously determined metrics and even artificial intelligence concepts for optimization of what may be considered empirical and even grower-specific, plant-specific, or locale-specific environments.

Some processes may grow the customer plant along with a donor plant. Then based on cell size of the donor tray and customer tray; ball size of donor plant and customer plant; growth time; storage temperature; soil composition; humidity; planned (and dynamically adjustable in real time) growth environments; specific order fulfillment requirements (which may constantly change and may also be dynamically adjustable in real time) and other factors may be applied or incorporated to determine when to optimally donate or punch machine transplant a donor plant from the donor tray to the customer tray. A combined relation or perhaps metric of ball size, average donor tray life, plant punch related parameters, anticipated customer order volumes, and other growth factors may be useful in optimizing donor tray efficiency. In some embodiments having a complex relation, perhaps even having a polynomial of a higher order, such as four or five linear dimensions (e.g., area multiplied by volume or the like) may be beneficial. One non-limiting example of this could be the cell area times volume of the root ball.

In another embodiment of a controlled process for improving donor efficiency, the system may utilize a more complex ratio algorithm of donor tray density and donor ball size to customer tray density and customer ball size to maximize the efficiency of utilizing a donor tray system. As with any complex ratio, these values may be arranged in any order to efficiently run a donor tray transplanting system. These ratios may also be related to the root ball size versus the size of the cell. There may be an ideal ratio or a range of ratios that may provide optimally efficient results.

Some embodiments may utilize a process based on plant cell punches or other automated plant removal processes to replace the donor tray. To efficiently transplant donor plants into customer trays, the current process may base decisions on limiting the number of empty punches or other automated plant removal processes per donor tray. When removing donor plants from a donor tray, empty cells result. When reusing the donor tray for an additional cycle of customer trays to efficiently transplant processes, embodiments may calculate which trays have empty cells, either visually or through a computer-controlled processes or imagery, such as but not limited to, camera sensing, infrared sensing, electromagnetic sensing, or Bluetooth uses, to name a few. The trays may then be positioned in the punching system or automated transplanting system to reduce the number of times the donor tray or a customer tray is repositioned. The system may also determine when it is more efficient to discard a tray than to punch or transplant around empty cells. For example, in a donor tray of 800 cells, when 675 cells are transplanted, it may be more efficient to replace the tray with a full tray rather than punch or move an automated transplanting system around the empty cell space(s). The operator or computer controller may determine and calculate the most efficient transplanting locations based on computer determined parameters or otherwise, perhaps with use of either the current date or data gathered from previous events of the same nature (similar customer orders may follow a pattern of punching or transplanting, making donating donor plants predictable) or using comparably located cells for those that need to be replaced. The computer logic (and/or operator involvement) then may make, indicate, or implement decisions on where to punch plants for the most efficient punching. This may enable the punch or other automated transplanting system or operator to limit or eliminate punching or selecting an empty donor tray cell or otherwise be more efficient.

In another embodiment of an optimally efficient donor process, to attain 100 percent order fulfillment, additional metrics may be utilized. It may be that the required number of trays correlates with the number of viable plants for a period of time dependent on donor tray storage metrics, such as, but not limited to, internal external or environmental temperature, time, and light. In other embodiments, to receive 100 percent or a high percentage of order fulfillment, new metrics may be generated. These metrics may not be exclusive to the process but may be an important part of the process and may even be the result of artificial intelligence in that any variables may be tested and applied for a particular operation. In some embodiments of efficient transplanting systems and methods it may be that the required trays or number of viable plants over a period of time is shown to be dependent on donor tray storage time percentage of non-viable plants in a tray, either actual or estimated, and/or equals the number of donor plants required for this period of time.

In another embodiment, a metrically controlled process may be based on, but not limited to, calculated factors and inventory data along with growth constants. A complex algorithm may be used to determine the optimal amount of donor plants required to achieve 100 percent order fulfillment. The growth constants may be but are not limited to the timing of transfer between donor plants and customer plants based on a function of days to complete germination (DG), the maximum period of time donor tray is in cold storage without plant degradation as a function of weeks donor tray is in cold storage (WCS), and configuration of the donor tray based on cell makeup (volume or size) of the tray (CT). The metrics for calculated factors and inventory data may include but are not limited to weekly demand for all tray sizes (WD), the germination rate of customer trays as a percentage (GRC), the germination rate of donor trays as a percentage (GRD), the number of donor plants in inventory (either in warm or cold storage) (DPI), the variability of seed quality factor as a percentage of variance in germination (VSQ), the total quantity of donor plants required based on optimal production goals (DPR), the risk factor to meet order fulfillment (100 percent being high risk and 0 percent being low risk) (RF), the number of future weeks required to calculate the total quantity of donor plants required based on optimal production goals (FWR), and the total demand for calculating donor requirements (TDC). The metrically controlled process to optimize donor transplanting efficiency may use a sophisticated algorithm that projects a future demand utilizing risk or other factors to optimize a required donor tray buffer. One possible equation may be to take the weeks in cold storage (WCS) multiplied by the risk factor (RF) to equal the number of future weeks required to calculate the total number of donor plants required (FWR). This may be used to determine the total demand for calculating the donor requirements (TDC) done by adding the current weekly demand (WD) with the number of future weeks required (FWR). Total demand (TDC) may then be used to calculate the number of donor plants required (DPR) by multiplying Total Demand (TDC) by one minus the germination rate on customer trays (1−GRC) by one plus the variability of seed quality factor (1+VSQ). The number of required donor plants (DPR) may then be used to determine the number of donor trays to be sown with current customer trays by Subtracting the donor plants in inventory from the required donor plants (DPR-DPI) and multiplying by the sequence of one plus one minus the germination rate on donor trays divided by the number of cells in the tray (1+(1−GRD)/CT). Utilizing the timing of transfer from donor tray to customer tray to ensure order fill by sowing donor tray may be beneficial to understand germination rates at earlier periods of time in the growing cycle. As one example, if the days to complete germination (DG) divided by the days in the week (7) is less than the maximum time donor trays are kept in cold storage without plant degradation ((DG/7)<WCS), then it may be beneficial to look at future demand to optimize the efficiency of an efficient transplanting system. The number of weeks to look for demand may be calculated by subtracting the values above days to complete germination (DG) divided by the days in the week (7) from the maximum time donor trays are kept in cold storage without plant degradation (WCS−(DG/7)). The number of weeks to look for demand may be beneficial in determining if there is demand; if there is demand donor trays may need to be sown ahead of customer trays. A simplified equation for calculating the required number of donor trays to be sown with respect to the current number of customer trays required for efficient transplanting may look like: Required Donor Trays=(WD+(WCS*RF)*(1−GRC)*(1+VSQ))−DPI)*(1+(1−GRD)/CT).

### BRIEF DESCRIPTION OF THE FIGURES

FIG. 1 is an exemplary embodiment of the present invention transplanting system showing a transplant plunger, donor tray, and customer tray.

FIG. 2A is an exemplary illustration of one embodiment of a high cell density donor tray.

FIG. 2B is an exemplary illustration of one embodiment of a low cell density customer/growth tray.

FIG. 3 is an exemplary diagram of one methodology of utilizing multiple donor trays.

FIG. 4 is an exemplary diagram of a method of transplanting using a high cell density donor tray.

FIG. 5 is an exemplary illustration of a method of allowing the transplant.

FIG. 6 is an exemplary diagram of a method for optimizing donor processes.

FIG. 7A is an exemplary illustration of an efficient transplanting system that utilizes a smaller donor root ball than the customer plant pre-donation.

FIG. 7B is an exemplary illustration of an efficient transplanting system that utilizes a smaller donor root ball than the customer plant post-donation.

FIG. 8 is an exemplary diagram of a method for efficiently optimizing order fulfillment.

FIG. 9 is an exemplary diagram of a method for optimizing donor tray replacement timing dependent on economic waste curves.

FIG. 10 is an exemplary diagram of a method for optimizing donor tray replacement timing dependent upon growth curves.

FIG. 11 is an exemplary embodiment of an automated, computer implemented efficient plant order fulfillment system.

FIG. 12 is another exemplary embodiment of an automated, computer implemented efficient plant order fulfillment system.

FIG. 13 is another exemplary embodiment of an automated, computer implemented efficient plant order fulfillment system.

### DETAILED DESCRIPTION

It should be understood that the present invention includes a variety of aspects, which may be combined in different ways. The following descriptions are provided to list elements and describe some of the embodiments of the present invention. These elements are listed with initial embodiments; however, it should be understood that they may be combined in any manner and in any number to create additional embodiments. The variously described examples and preferred embodiments should not be construed to limit the present invention to only the explicitly described systems, techniques, and applications. The specific embodiment or embodiments shown are examples only. The specification should be understood and is intended as supporting broad claims as well as each embodiment and even claims where other embodiments may be excluded. Importantly, disclosure of merely exemplary embodiments is not meant to limit the breadth of other more encompassing claims that may be made where such may be only one of several methods or embodiments which could be employed in a broader claim or the like. Further, this description should be understood to support and encompass descriptions and claims of all the various embodiments, systems, techniques, methods, devices, and applications with any number of the disclosed elements, with each element alone, and also with any and all various permutations and combinations of all elements in this or any subsequent application. This is particularly important for this disclosure because many variations and relationships can be applied to provide alternative embodiments and because artificial intelligence can be applied in manners where only correlations, not necessarily causalities may be developed in implementing these methods.

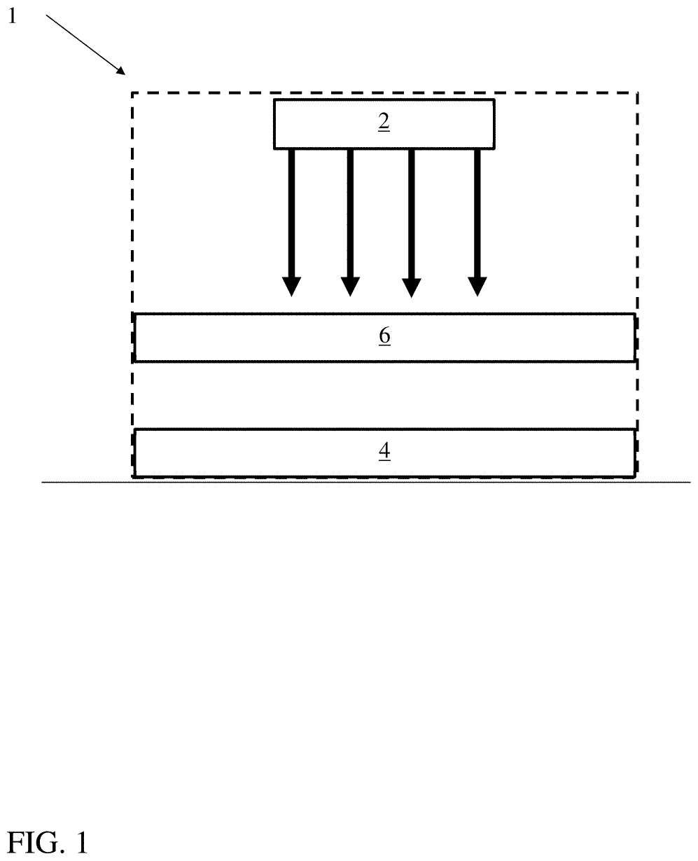

FIG. 1 is an exemplary embodiment of the present invention transplanting system showing a transplant plunger, donor tray, and customer tray. In some embodiments, the transplanting device (2) may be a transplant plunger, and in other embodiments there may be other, perhaps automated, transplanting equipment. In certain embodiments, a transplanting system (1) utilizing a low cell density donor tray (as seen in FIG. 3, 8) may be utilized. However, in certain embodiments, the present system may use a variety of different cell size customer, transplant, or growth trays (4) while utilizing a higher density donor tray (6). The donor tray (6) may have but is not limited to about, equal, double, or triple the number of cells that the customer tray (4) may have. The following detailed description discusses embodiments of this high-efficiency transplanting system (1) and method. This high-efficiency donor tray transplanting system (1) could be present in another type of horticulture transplanting system and is not limited to the embodiment described herein.

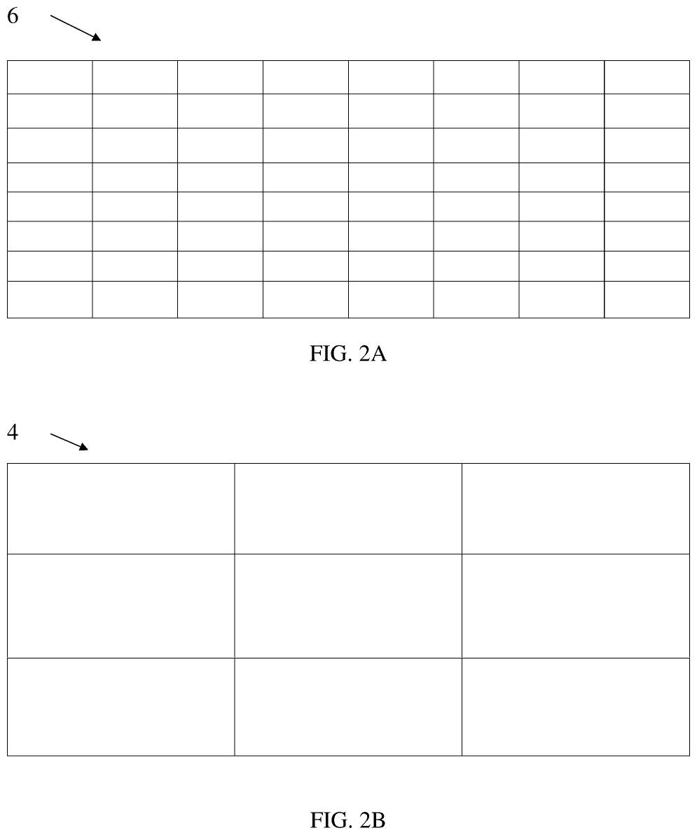

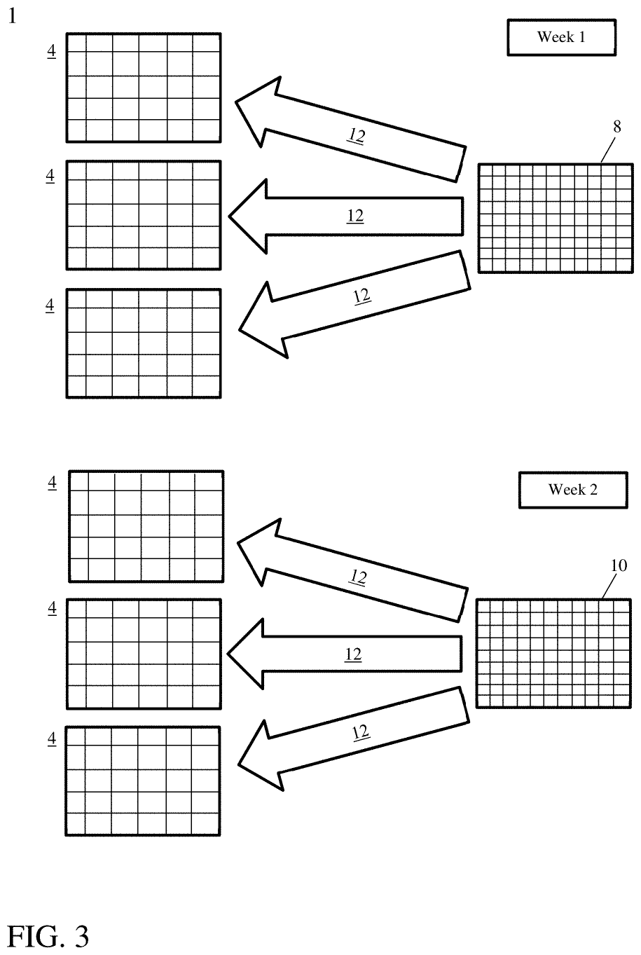

FIG. 2A and FIG. 2B are both exemplary cell density illustrations between a high cell density donor tray (6) and a low-density customer/growth tray (4). FIG. 2A is an exemplary illustration of one embodiment of a high cell density donor tray (6). FIG. 2B is an exemplary illustration of one embodiment of a low cell density customer/growth tray (4). In the present embodiment, the donor tray (6) may have, but is not limited to about, equal, double, or triple the number of cells that the customer/growth tray (4) may have. In certain embodiments, the cell density in the donor tray (6) may be higher than the customer tray (4). In yet other embodiments, ratios of cell densities can vary (even in one tray) such that the number of cells in a donor tray can be about or greater than about any of the following values: 1, 1.67, 2.0, 2.33, 2.5, 2.67, 3.0, and even 3.33, 4 times the number of cells in the retailer-salable or customer tray. Other further embodiments can provide optimal ratios; these values can be about or greater than the following values: 0.5, 0.75, 1, 1.25, 1.5, 2, 2.25. 2.67, 3, 3.25, and even four times smaller plant ball size between donor plant and customer plant. In yet other embodiments, ratios of cell density and plant ball size (exemplary but not limiting ratios of about 1:1, 1.25:1, 1.5:1, 1.75:1, 2:1, 3:1, and 4:1) can be combined and used even to the point of forming a new donor metric for production optimization. Even other embodiments can combine such metrics for a donor tray with uses across differing retailer saleable tray sizes and plant sizes for optimal efficiency.

FIG. 3 is an exemplary diagram of a donor tray methodology utilizing multiple donor trays (8, 10). In some embodiments of this method, the donor trays (8, 10) may have the same cell density as the customer tray (4). For example, when 30 donor plants (12) are transplanted from the donor tray (8, 10) to the customer tray (4), donor tray A (8) may be discarded. In some embodiments, during week two, a new donor tray B (10) may be planted, and in this example, 30 donor plants (12) may be transplanted to the customer tray (4). At the end of the week or otherwise desired transplant period, which may even be a pre- or metrically-determined optimal or appropriate time, the remaining contents of donor tray B (10) may be discarded. For large manufacturers, these methods and systems may be performed at large volumes. These methods and systems may also be performed individually. For certain plants or desired strains, customized conditions, including but not limited to ambient or room temperature or type of soil, may be included. Equal or other size customer and donor trays may be utilized with the efficient transplanting processes if it is optimal for economic costs, customer needs, or growth process needs.

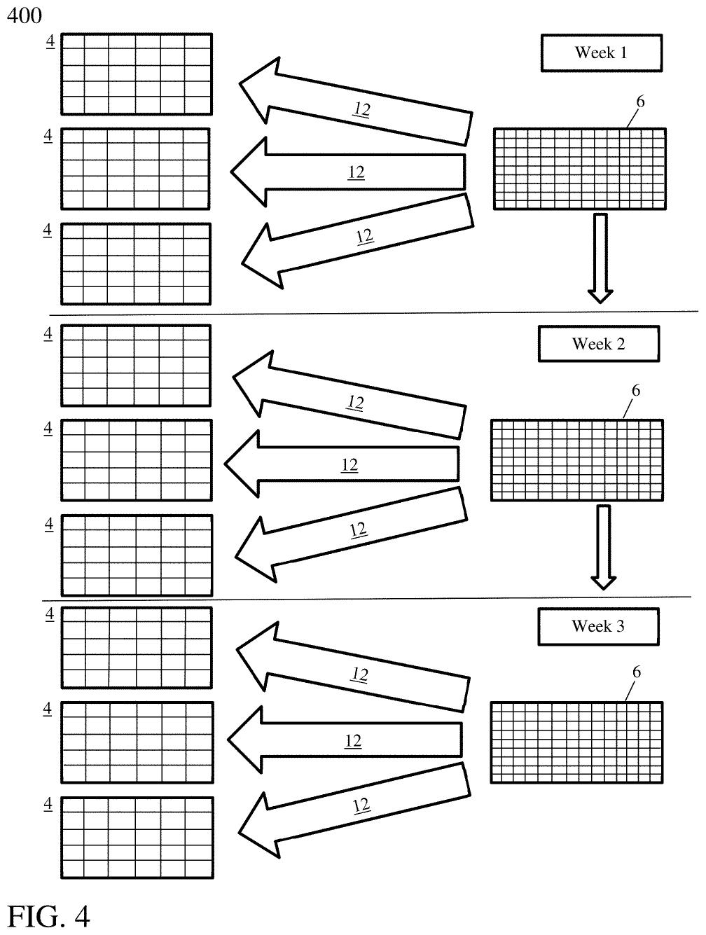

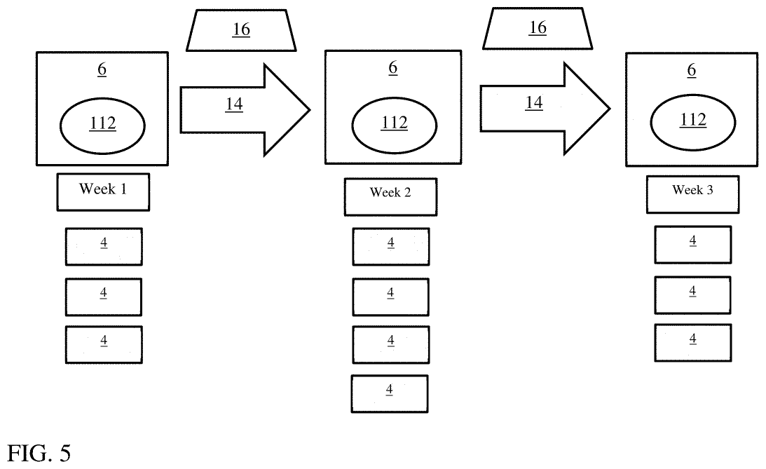

Significantly, FIG. 4 shows an improved likely more efficient method, perhaps even as compared to FIG. 3. FIG. 4 is an exemplary diagram of a method of transplanting using a high cell density donor tray. In this embodiment, the donor tray may have, but may not be limited to, 800 cells. The high cell density donor tray (6) may have differing dimensions (exterior size, volume, or area) than the customer tray (4) but does not have to be. The high cell density donor tray (6) may have the same conditions as the customer tray (4), but there may be embodiments where it may vary due to desired plant strains or other factors, for example. In this embodiment, the customer tray may have 300 cells. In this embodiment, utilizing a donor tray with a higher density of cells may be conducive to, among other items, having more efficient transplanting from a high cell density donor tray (6) to a customer tray (4), as the same high cell density donor tray (6) can be used for multiple weeks instead of being discarded. This may also help manufacturers in cost reduction, sustainability, and other desired production advantages. For large manufacturers, these methods and systems may be performed at large volumes. These methods and systems may also be performed individually. For certain plants or desired strains or otherwise, customized or tailored conditions, including but not limited to ambient or room temperature or type of soil, may be included.

FIG. 5 illustrates an exemplary method of using a single high cell density donor tray (6) over multiple weeks. Planting efficiency may be improved through the use of this method due to the high cell density donor tray (6) not being discarded after the first week. In the present embodiment, during week one, 800 cells of a high cell density donor tray (6) may be planted and 30 donor plants (12) may be transplanted to the customer tray. The remaining 770 donor plants (12) in the tray may be stored in cold storage, possibly under metrically controlled or indicated growth lamps (16), to facilitate a slower growth rate than the customer trays (4). Then possibly during week two, the high cell density donor tray (6) may be removed from cold storage (14), and 30 donor plants (12) may be transplanted, leaving 740 plants in the original week one high cell density donor tray (6). Further, this transplant can strategically occur at a slightly later point in the retailer saleable growth cycle as the donor plant may have aged albeit slower in the meantime. Then the high cell density donor tray (6), perhaps also considered an embodiment of a multi-cycle replacement tray, may be stored in metrically indicated or controlled cold storage (14) and under growth lamps (16) until week three. Then possibly during week three, 30 additional donor plants (12) may be transplanted. If feasible, the remaining 710 plants in the high cell density donor tray (6) may be put back into cold storage (14) and under growth lamps (16) to repeat the process. This present embodiment can efficiently manage the demands of different customer needs during different order periods. As illustrated, a period of one week is used, and the customer may have varying customer tray (4) quantities ordered per week. In week one and three, the customer may only require three full trays, while in week two, the customer may require an additional tray. Such may also be dynamically varied and embodiments of the system can react in real time.

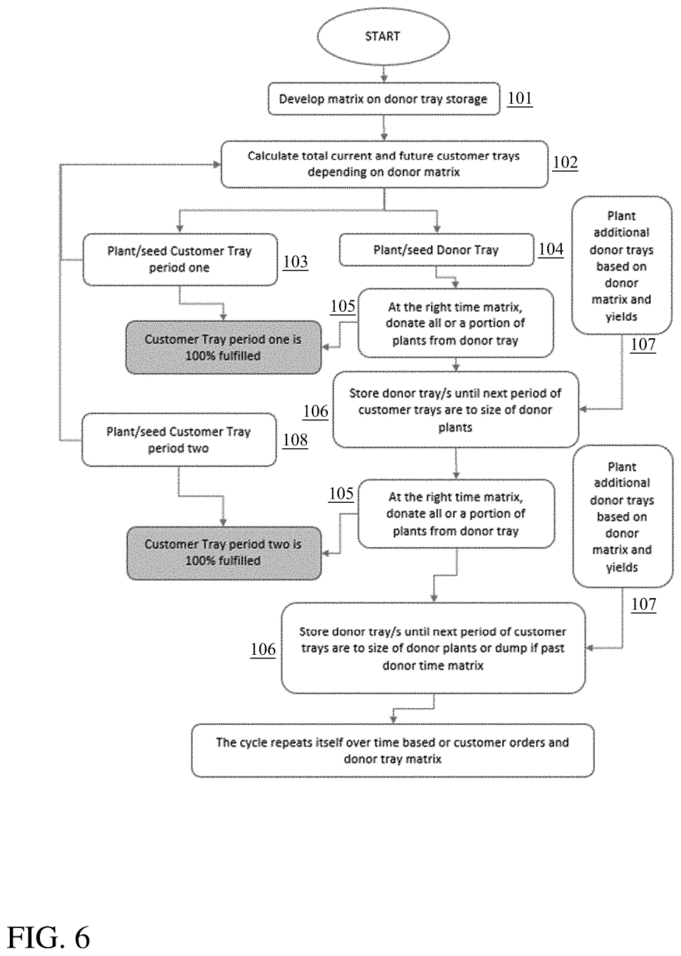

FIG. 6 illustrates an exemplary method for optimizing donor processes that may be varied or adapted for particular applications. In this embodiment, a matrix with varying control metrics may be created to determine donor tray storage (101). From this donor matrix, the total current and future customer tray requirements may be calculated (102). Based on this calculation, a first period/cycle of customer trays (103) and donor trays (104) may be planted, sown, or seeded. In some embodiments, the customer tray may have all propagules take, and the period one tray may be 100 percent fulfilled. During period one, at the optimal time calculated by the donor matrix, donation of all or a portion of plants from a donor tray may be translated, perhaps metrically, to the customer tray to achieve 100 percent order fulfillment for period one (105). Receiving inputs from the donor matrix and yields additional donor trays may be planted (107) and the period one donor tray may be stored until the next period of customer trays are to the size of the donor (106). Depending on the total current and future customer tray requirement calculated by the donor matrix, a second period customer tray may be planted, seeded, or sown (108). In some embodiments, the customer tray may have all propagules take, and the period two customer tray may be 100 percent fulfilled. During period two, at the optimal time calculated by the donor matrix, the donation of all or a portion of plants from a donor tray may be translated to the customer tray to achieve 100 percent order fulfillment for period two. Receiving inputs from the donor matrix and yields, additional donor trays may be planted and the period one donor tray may be stored until the next period of customer trays are to the size of the donor tray or an otherwise appropriate time, perhaps as determined or indicated by the computer system or logic. Based on the donor metrics and the donor matrix, it may be optimal to store donor trays until the next period of customer trays are the size of the donor plants or to discard (dump) the donor plants if past the optimal time determined from the donor matrix. The cycle may then repeat itself based on a time-based model, customer requirements and orders, and/or the donor tray metrics-based matrix.

In another embodiment of this process, the process may be started by planting a customer tray (4) and donor tray (6) sequentially. The plants in both trays may be given the appropriate time to grow and this can be metrically determined by computer logic or indications to an operator. Then a donation of plants (12) from the donor tray to the customer tray may occur to replace any damaged, dead, or unsuitable-for-delivery plants in the customer tray. The customer trays (4) may then be used to fulfill the customer orders. Occurring simultaneously or before or after order fulfillment, the economic viability of continued use of the donor tray may be assessed, perhaps based on a series of combined metrics. From this assessment, the donor tray (6) may be considered either economically viable or unviable or economically optimal or sub-optimal. If the donor tray (6) is viable, the tray may be stored under controlled cold storage (14) and/or growth lamps (16) to stunt growth in order to be used for an additional cycle of customer tray plant growth. If the donor tray (6) is considered unviable, then the tray may be discarded, and the new donor tray may be planted, and as above, this process may repeat itself based on a time-based model, customer requirements and orders, and/or the donor tray metrics-based matrix. This may even have adjustments in real time as conditions or ordering changes.

In some embodiments, it may be beneficial to provide a method of cultivating plants for efficient order fulfillment. In some embodiments this may be accomplished by, but is not limited to, utilizing prior propagule growth information to quantitatively develop multi-cycle horticultural growth relationships; developing at least one multi-cycle replacement tray maximization metric; programming the multi-cycle replacement tray maximization metric for automated operation by a programmable plant growth configured computer system; determining the multi-cycle future propagule order fulfillment requirement; inputting the multi-cycle future propagule order fulfillment requirement into the multi-cycle replacement tray maximization metric for automated operation in a programmable plant growth configured computer system; primarily growing a first cycle customer tray having a plurality of propagules as automatically provided for a program implemented to utilize at least one multi-cycle replacement tray maximization metric in a programmable plant growth configured computer system; at least part simultaneously differentially growing a multi-cycle replacement tray based on the multi-cycle future propagule order fulfillment requirement and at least one multi-cycle replacement tray maximization metric as automatically indicated by the program to optimize multi-cycle replacement tray maximization metric in a programmable plant growth configured computer system; first programmable plant growth configured computer system accepting a valid replacement need; first indicating a transplant on a programmable plant growth configured computer system as a result of the step of automatically providing for a program implemented to utilize at least one multi-cycle replacement tray maximization metric in a programmable plant growth configured computer system; transplanting a multi-cycle replacement tray propagule from said multi-cycle replacement tray to replace a defective first cycle customer tray propagule in said first cycle customer tray through use of an automated propagule punch system; primarily growing a second cycle customer tray having a plurality of second cycle customer tray propagules as automatically provided for a program implemented to utilize at least one multi-cycle replacement tray maximization metric in a programmable plant growth configured computer system; second programmable plant growth configured computer system accepting a valid replacement need; second indicating a transplant on a programmable plant growth configured computer system as a result of the step of automatically providing for a program implemented to utilize at least one multi-cycle replacement tray maximization metric in a programmable plant growth configured computer system; and transplanting a multi-cycle replacement tray propagule from a multi-cycle replacement tray to replace a defective second cycle customer tray propagule through use of an automated propagule punch system. In other embodiments, additional steps may be added, and, in some embodiments, steps may be removed. Steps may be performed in any rational order.

In some embodiments a first programmable plant growth configured computer system accepting a valid replacement need may be accomplished at any period in the cycle time by either a certified or approved operator or computer program that determines the replacement need. In another embodiments first indicating a transplant on a programmable plant growth configured computer system as a result of the step of automatically providing for a program implemented to utilize at least one multi-cycle replacement tray maximization metric in a programmable plant growth configured computer system may be accomplished by indicating at anytime by an operator or computer alert program. If utilizing a computer alert program the indication control may be autonomously indicated in the program implemented to utilize at at least one multi-cycle replacement tray maximization metric in a programmable plant growth configured computer system.

In some embodiments, at least part simultaneously differentially growing a multi-cycle replacement tray based on a multi-cycle future propagule order fulfillment requirement and at least one multi-cycle replacement tray maximization metric may be accomplished by secondarily differentially growing a multi-cycle replacement tray based on said multi-cycle future propagule order fulfillment requirement. In other embodiments, a multi-cycle replacement tray may have a higher cell density multi-cycle replacement tray than a first cycle customer tray, having a first cycle customer tray cell density. In some embodiments, a multi-cycle replacement tray may have a multi-cycle replacement tray cell density at least three times that of the first cycle customer tray, having a first cycle customer tray cell density. In some embodiments, a multi-cycle replacement tray may have a higher cell density multi-cycle replacement tray than a second cycle customer tray, having a second cycle customer tray cell density, having a second cycle customer tray cell density, having a second cycle customer tray cell density. In another embodiment, a multi-cycle replacement tray may have a multi-cycle replacement tray cell density at least three times that of a second cycle customer tray, having a second cycle customer tray cell density, having a second cycle customer tray cell density.

In some embodiments transplanting a multi-cycle replacement tray propagule from a multi-cycle replacement tray to replace a defective first cycle customer tray propagule in said first cycle customer tray through use of an automated propagule, the punch system comprises a system to automatically replace at least one replacement tray propagule through an automated propagule punch system. An automated propagule punch system may be computer controlled through the use of sensors, cameras, other external inputs, and the like. Embodiments may merely indicate and direct operator actions to achieve the computer determined process. In other embodiments, the overall system, and/or an automated propagule punch system, may be computer controlled to be artificially intelligent and to make transplant decisions based on machine learning algorithms.

In some embodiments, at least one multi-cycle replacement tray maximization metric comprises a future projection of transplant propagule need metric. In some embodiments, a future projection of transplant propagule need comprises a 100 percent or near 100 percent (within 10 percent) customer order fulfillment metric.

In some embodiments, the step of utilizing prior propagule growth information to quantitatively develop multi-cycle horticultural growth relationships may be accomplished by utilizing prior growth cycle data to determine the optimal multi-cycle growth relationships. This may include looking at prior or current horticulture growth date for growing time, growing conditions, growing speed, or the like. In another embodiment, the step of developing at least one multi-cycle replacement tray maximization metric may include but is not limited to utilizing metrics that may be beneficial in the multi-cycle growth of plants such as but not limited to propagule grow environment humidity, storage environment humidity, soil type, feedwater flow rate, the weekly or cycle demand, germination rate of customer tray, germination rate of donor tray, the number of plants in inventory, the seed quality factor as variance in germination, donor plants required, the qualified risk factor or risk factor, the number of future weeks required for donor plants, total demand for donor plants, consumer plant time under light, donor plant time under light, donor/replacement tray time under storage, donor/replacement tray and plant cold storage time, or the like.

In some embodiments, the step of programming a multi-cycle replacement tray maximization metric for automated operation by a programmable plant growth configured computer system may be accomplished by a programmable plant growth configured computer system that is any combination of devices or a computational device such as cloud computing software and hardware, a computer, tablet, cellular phone, or the like. In some embodiments, a valid replacement need may be a programmable plant growth configured computer system accepting a command from a user or an input from another computer system. It may also provide inputs or outputs itself. In some embodiments, an input may be a visual detection of a defective plant by perhaps an authorized or certified user, or through a computer-controlled vision system utilizing cameras, sensors, or the like to determine when a plant is deemed defective. This may even be determined from artificial intelligence implementing outcomes for each customer individually. In some embodiments, replacement of a defective customer tray propagule through the use of an automated plant punch system may be accomplished through the computer-controlled punching of replacement tray propagules into customer tray propagules as described above.

In some embodiments, it may be beneficial to provide a method of cultivating plants for efficient order fulfillment. In some embodiments this may be accomplished by, but is not limited to, utilizing prior propagule growth information to quantitatively develop multi-cycle horticultural growth relationships; determining at least one multi growth stage parameterized metric; programming said multi growth stage parameterized metric for automated operation by a programmable plant growth configured computer system; utilizing said at least one multi growth stage parameterized metric to configure a reduced replacement metrically controlled process to replace a customer tray propagule; calculating a reduced replacement parameter based on a future customer tray propagule need; and inputting at least one multi growth stage parameterized metric into a reduced replacement metrically controlled process for automated operation in said programmable plant growth configured computer system; replacing at least one customer tray propagule with an automated plant punching system; utilizing the reduced replacement parameter to maximally fulfill the future customer tray propagule need, and the like. In other embodiments, additional steps may be added, and, in some embodiments, steps may be removed. Steps may be performed in any rational order.

In some embodiments, the step of utilizing prior propagule growth information to quantitatively develop multi-cycle horticultural growth relationships may be accomplished by utilizing prior growth cycle data to determine the optimal multi-cycle growth relationships. This may include looking at prior or current horticulture growth date for growing time, growing conditions, growing speed, or the like. In another embodiment, the step of determining at least one multi growth stage parameterized metric may include but is not limited to utilizing metrics that may be beneficial in the multi-cycle growth of plants such as but not limited to propagule grow environment humidity, storage environment humidity, soil type, feedwater flow rate, the weekly or cycle demand, germination rate of customer tray, germination rate of donor tray, the number of plants in inventory, the seed quality factor as variance in germination, donor plants required, the qualified risk factor or risk factor, the number of future weeks required for donor plants, total demand for donor plants, consumer plant time under light, donor plant time under light, donor/replacement tray time under storage, donor/replacement tray and plant cold storage time, or the like.

In some embodiments, the step of programming a multi growth stage parameterized metric for automated operation by a programmable plant growth configured computer system may be accomplished by a programmable plant growth configured computer system that is any combination of devices or a computational device such as cloud computing software and hardware, a computer, tablet, cellular phone, or the like. In some embodiments, a valid replacement need may be a programmable plant growth configured computer system accepting a command from a user or an input from another programmable plant growth configured computer system. an input may be a visual detection of a defective plant by a user or through a computer-controlled vision system utilizing cameras, sensors, or the like to determine when a plant is defective. In some embodiments, replacing at least one customer tray propagule with an automated plant punching system may be accomplished through the computer-controlled punching of replacement tray propagules into customer tray propagules as described above.

In some embodiments, it may be beneficial to provide a method of cultivating plants for efficient order fulfillment. In some embodiments this may be accomplished by but is not limited to utilizing prior propagule growth information to quantitatively develop multi-cycle horticultural growth relationships; determining a multi growth stage parameterized metric; programming a multi growth stage parameterized metric for automated operation by a programmable plant growth configured computer system; utilizing said multi growth stage parameterized metric to configure metrically controlled processes to optimize order fulfillment production yield; inputting said at least one multi growth stage parameterized metric into said reduced replacement metrically controlled process to optimize order fulfillment production yield for automated operation in said programmable plant growth configured computer system; replacing at least one customer tray propagule with an automated plant punching system; achieving a metrically optimized order fulfillment production yield which is statistically optimized as compared to a traditional transplant production yield, and the like. In other embodiments, additional steps may be added, and, in some embodiments, steps may be removed. Steps may be performed in any order.

In some embodiments, the step of utilizing prior propagule growth information to quantitatively develop multi-cycle horticultural growth relationships may be accomplished by utilizing prior growth cycle data to determine the optimal multi-cycle growth relationships. This may include looking at prior or current horticulture growth date for growing time, growing conditions, growing speed, or the like. In another embodiment, the step of determining a multi growth stage parameterized metric may include but is not limited to utilizing metrics that may be beneficial in the multi-cycle growth of plants such as but not limited to propagule grow environment humidity, storage environment humidity, soil type, feedwater flow rate, the weekly or cycle demand, germination rate of customer tray, germination rate of donor tray, the number of plants in inventory, the seed quality factor as variance in germination, donor plants required, the qualified risk factor or risk factor, the number of future weeks required for donor plants, total demand for donor plants, consumer plant time under light, donor plant time under light, donor/replacement tray time under storage, donor/replacement tray and plant cold storage time, or the like.

In some embodiments, the step of programming said multi growth stage parameterized metric for automated operation by a programmable plant growth configured computer system may be accomplished by a programmable plant growth configured computer system that is any combination of devices or a computational device such as cloud computing software and hardware, a computer, tablet, cellular phone, or the like. In some embodiments, a valid replacement need may be a programmable plant growth configured computer system accepting a command from a user or an input from another computer system. an input may be a visual detection of a defective plant by a user or through a computer-controlled vision system utilizing cameras, sensors, or the like to determine when a plant is defective. In some embodiments, replacing at least one customer tray propagule with an automated plant punching system may be accomplished through the computer-controlled punching of replacement tray propagules into customer tray propagules as described above.

In some embodiments, utilizing a multi growth stage parameterized metric to configure metrically controlled processes to optimize order fulfillment production yield may be accomplished by optimizing or minimizing transplant propagule waste. In some embodiments, transplant propagule waste may be an economic waste due to increased growing costs or may be the quantitative waste of un-transplanted replacement plants. In other embodiments, the above step may be accomplished by optimizing a transplant propagule yield to customer propagule ratio. In this it may be that the number of transplant propagules needs to be minimized while maximizing the customer propagule ratio.

In some embodiments, it may be beneficial to provide a method of cultivating plants for efficient order fulfillment. In some embodiments, this may be accomplished by but is not limited to primarily growing at least one original customer tray having a plurality of propagules; replacing at least one defective propagule of a plurality of propagules with a replacement tray propagule; secondarily differentially growing said original customer tray having at least one propagule of a plurality of propagules and a replacement tray propagule. In other embodiments, additional steps may be added and, in some embodiments, steps may be removed. Steps may be performed in any order.

In some embodiments, the step of differentially growing an original customer tray having at least one propagule of a plurality of propagules and a replacement tray propagule may be accomplished by growing a replacement tray propagule based on a metrically controlled processes compositely with a customer tray propagule need. In some embodiments, a metrically controlled process may include a process that utilizes varying metrics such as limited to propagule grow environment humidity, storage environment humidity, soil type, feedwater flow rate, the weekly or cycle demand, germination rate of customer tray, germination rate of donor tray, the number of plants in inventory, the seed quality factor as variance in germination, donor plants required, the qualified risk factor or risk factor, the number of future weeks required for donor plants, total demand for donor plants, consumer plant time under light, donor plant time under light, donor/replacement tray time under storage, donor/replacement tray and plant cold storage time, or the like to metrically control the growth of a replacement tray propagule. In some embodiments, a customer tray propagule need may be a number of customer plants that need to be fulfilled in a customer order or the total customer plants needed for a specific growing cycle or the like. Additionally, in another embodiment, growing a replacement tray propagule based on a metrically controlled processes compositely with a customer tray propagule need may be accomplished by utilizing at least one multi growth stage parameterized metric. In some embodiments, a multi growth state parametrized metric may include the age of the customer and replacement plant, the time of growth of each plant, the weekly or cycle demand, germination rate of customer tray, germination rate of donor tray, the number of plants in inventory, the seed quality factor as variance in germination, donor plants required, the qualified risk factor or risk factor, the number of future weeks required for donor plants, total demand for donor plants, consumer plant time under light, donor plant time under light, donor/replacement tray time under storage, donor/replacement tray and plant cold storage time, or the like.

In some embodiments, it may be beneficial to provide a method of cultivating plants for efficient order fulfillment. In some embodiments, this may be accomplished by but is not limited to determining at least one multi-cycle replacement tray maximization metric; utilizing at least one multi-cycle replacement tray maximization metric to calculate a multi-cycle replacement tray cell parameter; a first cycle transplanting at least a first multi-cycle replacement tray propagule to replace a defective first cycle customer tray propagule; a second cycle transplanting at least a second multi-cycle replacement tray propagule to replace a defective second cycle customer tray propagule; optimally fulfilling orders utilizing said customer tray having said at least first multi-cycle replacement tray propagule and said at least second multi-cycle replacement tray propagule. In other embodiments, additional steps may be added, and, in some embodiments, steps may be removed. Steps may be performed in any order.

In some embodiments, the step of determining at least one multi-cycle replacement tray maximization metric may include but is not limited to utilizing metrics that may be beneficial in the multi-cycle growth of plants such as but not limited to propagule grow environment humidity, storage environment humidity, soil type, feedwater flow rate, the weekly or cycle demand, germination rate of customer tray, germination rate of donor tray, the number of plants in inventory, the seed quality factor as variance in germination, donor plants required, the qualified risk factor or risk factor, the number of future weeks required for donor plants, total demand for donor plants, consumer plant time under light, donor plant time under light, donor/replacement tray time under storage, donor/replacement tray and plant cold storage time, or the like. Multi-cycle growth may be but is not limited to utilizing the same donor/replacement propagule tray for multiple customer tray growth cycles.

In some embodiments, at least one multi-cycle replacement tray maximization metric may be at least one multi-cycle replacement tray maximization metric of a meaningful growth period. In some embodiments, a meaningful growth period may be a period where plant growth is sufficiently noticeable by metrics such as height, stalk thickness, petal area, root ball volume, or the like. A meaningful growth period may also be a growth period of greater than or equal to 24 hours or any other time metric.

In some embodiments, it may be beneficial to provide a method of cultivating plants for efficient order fulfillment. In some embodiments, this may be accomplished by but is not limited to determining at least one multi growth stage parameterized metric; utilizing at least one yield maximization metric to configure metrically controlled processes to replace a customer tray propagule; calculating a reduced replacement parameter based on future customer tray propagule need; interfacing at least one multi growth stage parameterized metric with an input module; inputting at least one multi growth stage parameterized metric to an input module; utilizing said reduced replacement parameter to maximize customer tray propagule cultivation; achieving maximize order fulfillment production yield which is statistically increased over a traditional transplant production period, or the like. In other embodiments, additional steps may be added, and, in some embodiments, steps may be removed. Steps may be performed in any rational order.

In another embodiment, the step of determining a multi growth stage parameterized metric may include but is not limited to utilizing metrics that may be beneficial in the multi-cycle growth of plants such as but not limited to propagule grow environment humidity, storage environment humidity, soil type, feedwater flow rate, the weekly or cycle demand, germination rate of customer tray, germination rate of donor tray, the number of plants in inventory, the seed quality factor as variance in germination, donor plants required, the qualified risk factor or risk factor, the number of future weeks required for donor plants, total demand for donor plants, consumer plant time under light, donor plant time under light, donor/replacement tray time under storage, donor/replacement tray and plant cold storage time, or the like. In some embodiments, calculating a reduced replacement parameter based on future customer tray propagule need may be accomplished by calculating the optimal replacement parameter based on the future order fulfillment need of a customer tray. A reduced replacement parameter may be but is not limited to a parameter that reduces the size, cost, or waste of a replacement tray propagule growth cycle. In some embodiments, achieving maximize order fulfillment production yield that is statistically increased over a traditional transplant production period may be accomplished by maximizing the customer order and reducing the amount of replacement/donor plant waste compared to traditional transplant production, which seeds a new donor tray for each customer tray cycle and discards the unused donor propagules.

In some embodiments, it may be beneficial to include the step of compositely calculating a reduced replacement parameter with said at least one yield maximization metric. A yield maximization metric may be propagule grow environment humidity, storage environment humidity, soil type, feedwater flow rate, the weekly or cycle demand, germination rate of customer tray, germination rate of donor tray, the number of plants in inventory, the seed quality factor as variance in germination, donor plants required, the qualified risk factor or risk factor, the number of future weeks required for donor plants, total demand for donor plants, consumer plant time under light, donor plant time under light, donor/replacement tray time under storage, donor/replacement tray and plant cold storage time, or the like. In some embodiments, calculating a reduced replacement parameter based on future customer tray propagule need may be accomplished by calculating the optimal replacement parameter based on the future order fulfillment need of a customer tray, or the like. In some embodiments, a metrically controlled process may include operator visual detection, computer detection, or the like.

In some embodiments, it may be beneficial to provide a method of cultivating plants for efficient order fulfillment. In some embodiments, this may be accomplished by but is not limited to determining at least one multi growth stage parameterized metric for transplanting propagules; utilizing at least one yield maximizing metric for transplanting propagules in a donor matrix configured and arranged to calculate an optimal time and a future propagule requirement; calculating an optimal time and the future propagule requirement to optimize transplant efficiencies; reducing transplant propagule waste through optimized transplant efficiencies, and the like. In some embodiments, steps may be added, and, in some embodiments, steps may be removed. Steps may be performed in any rational order.

In some embodiments, the step of determining at least one multi growth stage parameterized metric for transplanting propagules may be but is not limited to utilizing metrics that may be beneficial in the multi-cycle growth of plants such as but not limited to propagule grow environment humidity, storage environment humidity, soil type, feedwater flow rate, the weekly or cycle demand, germination rate of customer tray, germination rate of donor tray, the number of plants in inventory, the seed quality factor as variance in germination, donor plants required, the qualified risk factor or risk factor, the number of future weeks required for donor plants, total demand for donor plants, consumer plant time under light, donor plant time under light, donor/replacement tray time under storage, donor/replacement tray and plant cold storage time, or the like. In some embodiments, an optimal time may be the optimal transplant propagule storage time, the optimal transplant propagule growth time, or the like. In some embodiments, future propagule requirements may be the future customer order propagule need. In some embodiments, it may be beneficial to utilize multi-cycle replacement trays that have a higher propagule cell density than that of a first or second cycle customer tray. Cell density may be the cells per tray area, and in some embodiments a multi-cycle replacement tray may have at least two or three times the number of propagule cells than that of a first or second cycle customer tray.

In some embodiments, it may be beneficial to utilize a reduced replacement parameter that may be a root ball volume ratio or have a replacement tray root ball volume being at least two times smaller than a customer tray root ball volume. In other embodiments the root ball volume ratio may be transplant tray to customer tray root ball volume and may be 1:2, 1:3, or 1:4. In some embodiments it may also be beneficial to utilize a multi growth stage parameterized metric program that may be a root ball volume ratio metric or have a replacement tray root ball volume being at least two times smaller than a customer tray root ball volume metric.

In some embodiments, it may be beneficial to utilize a multi-cycle replacement tray maximization metric that may be a root ball volume ratio or have a replacement tray root ball volume being at least two times smaller than a customer tray root ball volume. In other embodiments the root ball volume ratio may be transplant tray to customer tray root ball volume and may be 1:2, 1:3, or 1:4. In some embodiments it may also be beneficial to utilize a multi-cycle replacement tray maximization metric program that may be a root ball volume ratio metric or have a replacement tray root ball volume being at least two times smaller than a customer tray root ball volume metric.

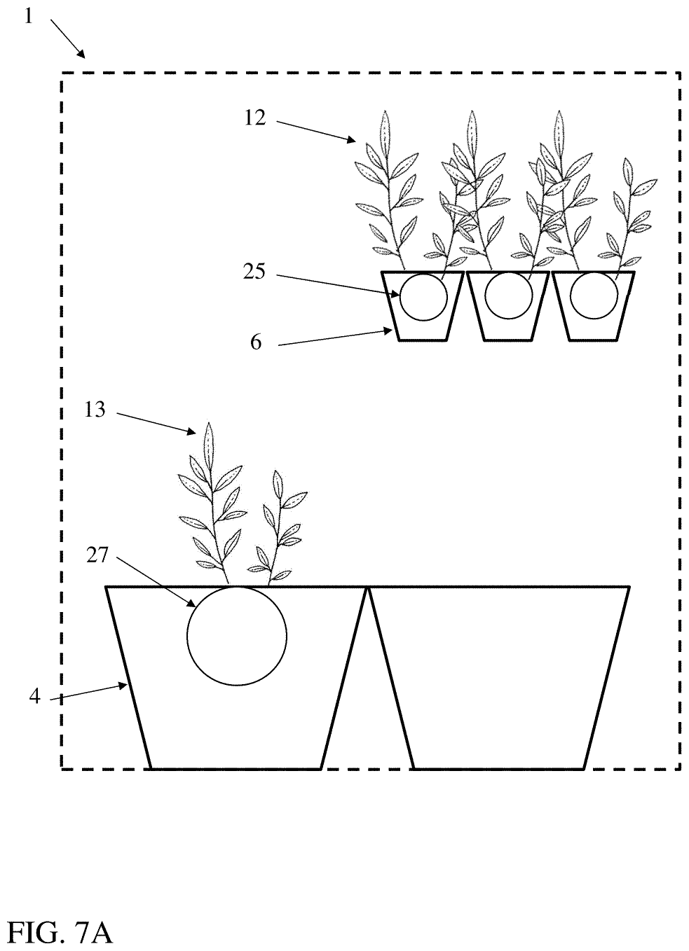

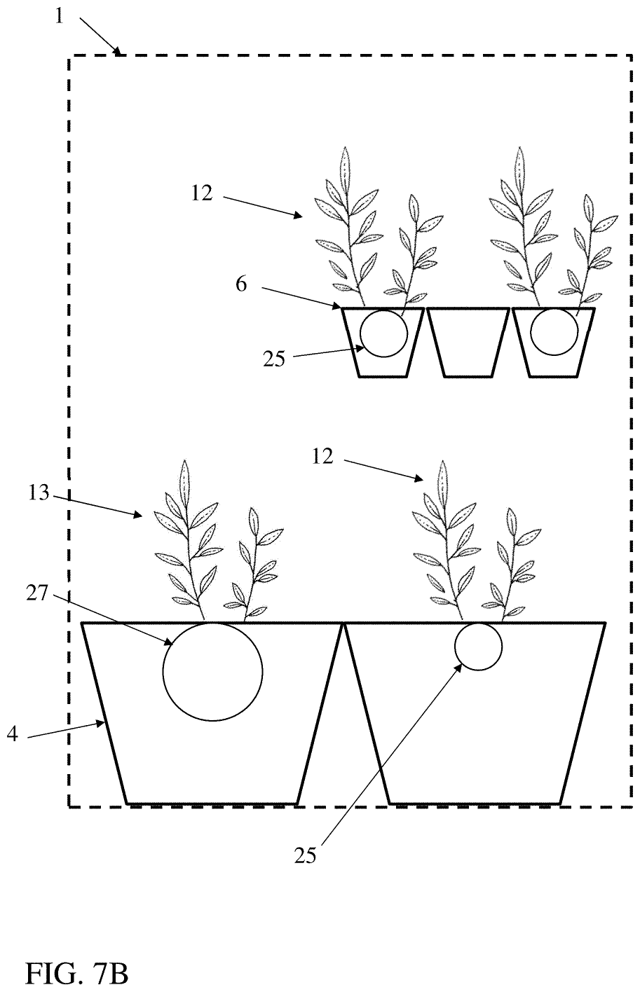

FIG. 7A and FIG. 7B are both exemplary illustrations of a transplanting system that utilizes differing size root balls. FIG. 7A is an exemplary illustration of an efficient transplanting system (1) that may utilize a smaller donor root ball (25) than the customer plant (13) pre-donation. In one embodiment, it may improve efficiency if differing root ball sizes are utilized. Most likely, a smaller root ball (25) donor plant (12) may be donated to the customer tray (4). The customer tray plant (13) may have a larger root ball (27) than the donor tray plant (12) due to environmental growing conditions, amount of growth light, a larger tray volume, or any other variety of growth factors. FIG. 7B is an exemplary illustration of a transplanting system that may utilize a smaller donor root ball (25) than the customer plant (13) post-donation. In this illustration, the donor plant (12) with a smaller root ball (25) has been transplanted to the customer tray (4) from the donor tray (6). It may be efficient to transplant this way to meet customer demands.

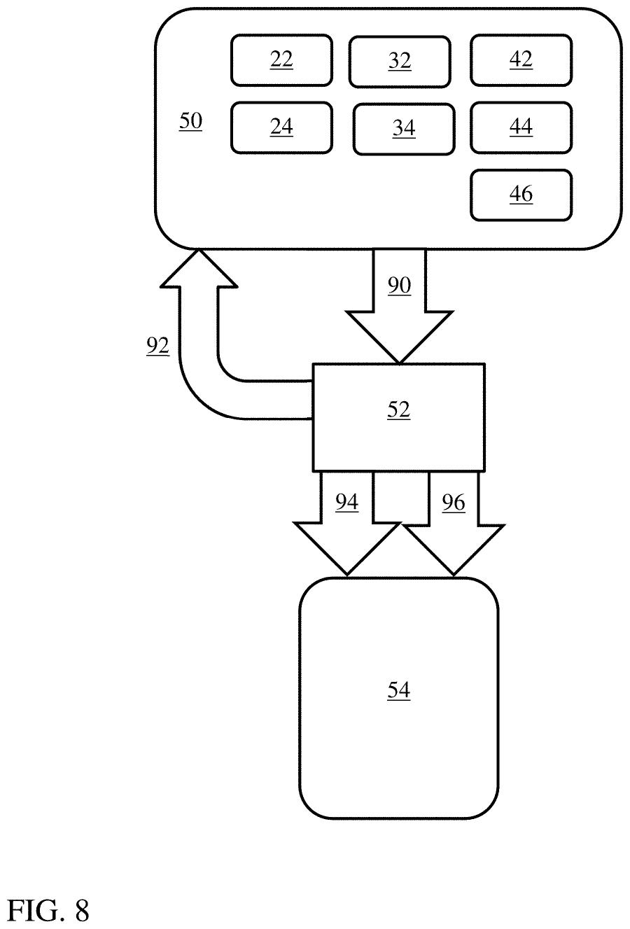

FIG. 8 is an exemplary diagram of one method for efficiently optimizing order fulfillment. In this embodiment, there may be an input module (50) that may consist of varying sensors and/or user identified conditions. The input module (50) may be a collection of sensors or conditions that may be input from an operator. The input module (50) may consist of, as but a few examples, grow temperature sensors (32) and storage temperature sensors (34). These temperature sensors may be but are not limited to, thermocouples, resistance temperature detectors, thermistors, infrared sensors, semiconductor-based integrated circuits, or analog thermometers. The input module (50) may also consist of an input for cell size (22) and root ball size (24). These inputs may be through imaging or through manual input by an operator from taking measurements. The imaging technology that may be utilized may be, but is not limited to, x-ray, ultrasonic, laser, photoimaging, or manual operator (perhaps authorized or certified) ranked measurement. The cell size input (22) may be utilized for one or both the customer tray (4) and donor tray (6). Similarly, the root ball input (24) may be utilized to measure or rank the donor tray plant small root ball (25) or the customer tray plant large root ball (27). In one embodiment, the input module (50) may utilize a soil composition input (44). This soil composition input (44) may utilize a variety of constraints such as nutrient data, soil moisture content, and, but not limited to, physical composition (for example, grain size, dirt mixture). The input module (50) may utilize a humidity sensor (46) that may measure the environmental growing conditions of the growing tray/customer tray (4) and the donor tray (6). The humidity sensor may be but is not limited to, a resistive type sensor, a capacitive type sensor, a thermal conductive type sensor, or operator visual input. In another embodiment, there may be a need to optimize efficiency by determining which plant type is being sown. The input module (5) may utilize a plant type input (42). This plant type input (42) may utilize an imaging sensor and computer-controlled database or may be input by an operator (perhaps authorized or certified) from visual inspection. The data input into the input module (50) may then be transferred or input (90) to a central processing unit (52). The central processing unit or logic may be utilized to analyze the combined metrics from the input module, or it may be an indicated decision-making to prompt a step performed by the growth operator. The central processing unit may, but is not limited to, utilize a series of algorithms or programmed and stored logic functions to make a decision on whether to indicate or transplant a donor plant, return output (92) that sends the process to the start, or a discard output (96). If the central processing unit may determine that it is optimally efficient to donate a donor plant, a donating output (94) may be sent to the output module (54). In some embodiments, the output module may connect directly to a transplanting system to donate a donor plant (13) without input from an operator. In some other embodiments, the output module (54) may alert an operator to perform a predetermined function. The discard output (96) may be done without user input or be controlled by an operator.

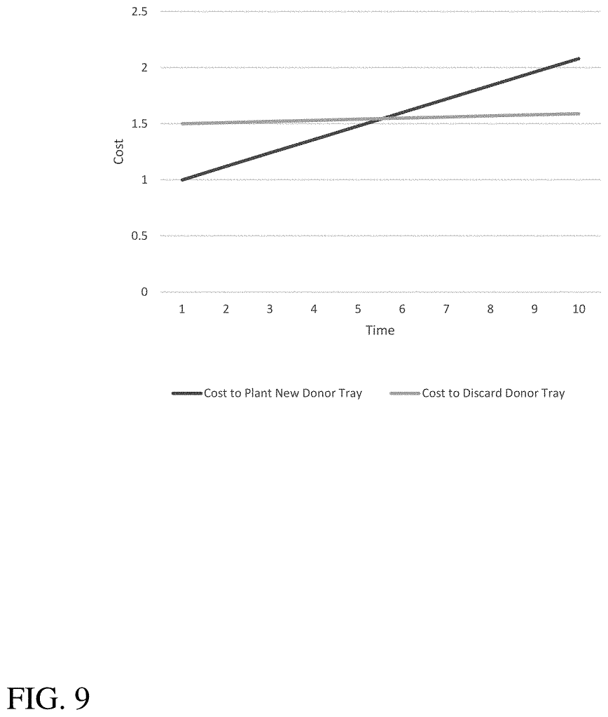

FIG. 9 is an exemplary diagram to illustrate a method for optimizing donor tray replacement timing dependent on economic waste curves. In some embodiments, it may be beneficial to improve efficiency by utilizing donor waste decision-making processes. These processes may include a metric approach to using the cost of storage, plant viability, and/or plant age or other factors to decide when it is efficient from a process point of view to discard a donor tray. As displayed in FIG. 9, there may be an intersection point where the cost to plant a new donor tray and the cost to discard the donor tray meet. This may be the point at which it is more efficient to switch from using a multiple cycle donor tray (6) to planting a new donor tray. In this illustration, the cost and time values are merely figurative and are not representative of actual values that may be seen or utilized in the production process.

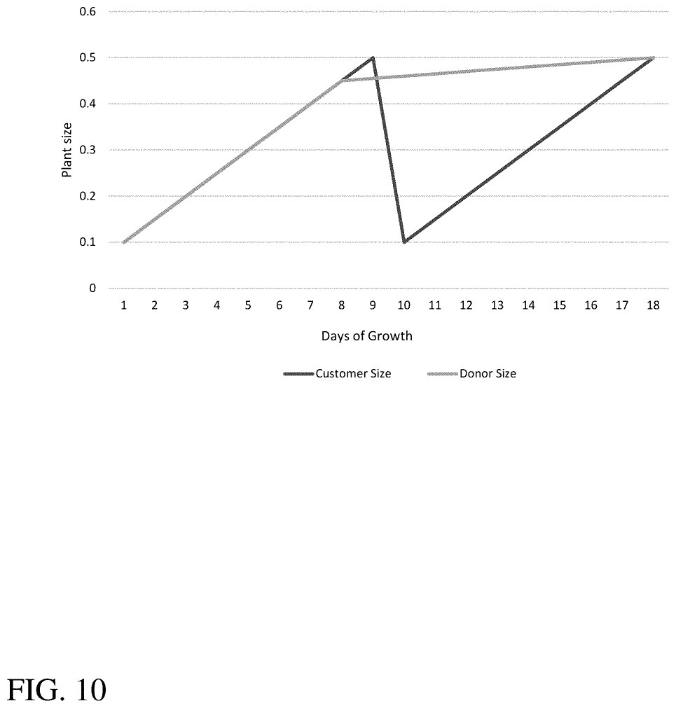

FIG. 10 is an exemplary diagram of a method for optimizing donor tray replacement timing dependent upon growth curves. As illustrated, the curve may relate to plant size versus days for growth; however other parameters may be substituted from the other metrics used to determine an optimally efficient time to transplant. Some metrics may include, but are not limited to, humidity, soil type, feedwater flow rate, time under light, the size of donor root ball compared to customer plant root ball size, the cost of donor tray compared to cost of donor waste, or the complex ratio between donor plant and customer plant. In another embodiment, an efficient transplanting system may utilize a system or process that may use a metrically controlled replacement timer. A replacement timer may be a combination of growth curves and computer or operator-controlled methods. A replacement timer growth curve may track the size of the customer plant, size of a donor plant, customer plant time spent growing, and set this equal to donor time spent growing under ambient plus donor time spent growing under cold operated on by a constant. In this illustration, the plant size and days of growth values are merely figurative and are not representative of actual values that may be seen or utilized in the production process.

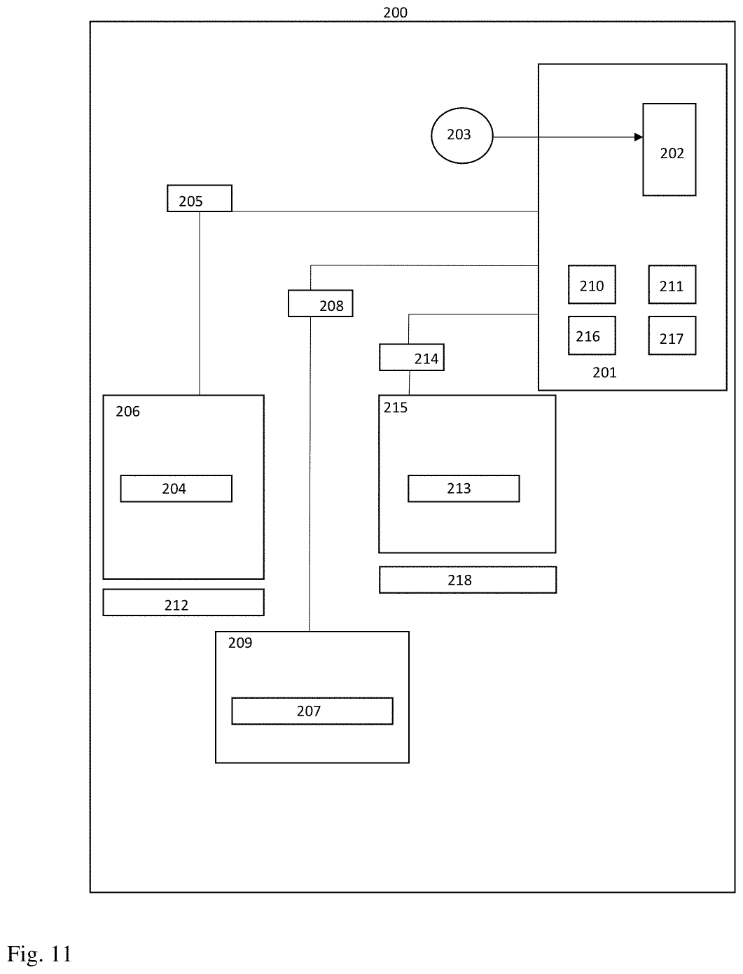

FIG. 11 is an exemplary embodiment of an automated, computer implemented efficient plant order fulfillment system. In some embodiments, it may be beneficial to include an automated, computer implemented efficient plant order fulfillment system. In some embodiments, an automated, computer implemented efficient plant order fulfillment system may include but is not limited to a programmable plant growth configured computer system (201); at least one computer stored, multi-cycle replacement tray maximization metric program stored in said programmable plant growth configured computer system, wherein said at least one computer stored, multi-cycle replacement tray maximization metric program includes parameters based on prior propagule growth information, and includes quantitative plant multi-growth stage parameterized horticultural growth relationships (202); a multi-cycle future propagule order fulfillment requirement input for said programmable plant growth configured computer system, and that interfaces with said at least one computer stored, multi-cycle replacement tray maximization metric program (203); a first cycle customer tray having a plurality of propagules (204); a first cycle customer tray primary growth environment control having an operator interface with said programmable plant growth configured computer system (205); a first cycle customer primary growth environment configured to influence said first cycle customer tray, and to operate as automatically provided for a program implemented to utilize said at least one multi-cycle replacement tray maximization metric in said programmable plant growth configured computer system (206); a multi-cycle replacement tray having a plurality of donor propagules (207); an at least partly simultaneous, differential donor growth environment control having an operator interface with said programmable plant growth configured computer system (208); a donor growth environment configured to operate as automatically provided for a program implemented to utilize said at least one multi-cycle replacement tray maximization metric in said programmable plant growth configured computer system (209); a first cycle customer tray automated propagule punch system (212); a second cycle customer tray having a plurality of propagules (213); a second cycle customer tray primary growth environment control having an operator interface with said programmable plant growth configured computer system (214); a second cycle customer primary growth environment configured to influence said second cycle customer tray, and to operate as automatically provided for a program implemented to utilize said at least one multi-cycle replacement tray maximization metric in said programmable plant growth configured computer system (215); and a second cycle customer tray automated propagule punch system (218).

In some embodiments, it may be beneficial to include an automated, computer implemented efficient plant order fulfillment system may further include a first replacement need acceptance subroutine stored in a programmable plant growth configured computer system (210); a first transplant indicator stored in a programmable plant growth configured computer system (211); a second replacement need acceptance subroutine stored in a programmable plant growth configured computer system (216); a second transplant indicator stored in a programmable plant growth configured computer system (217), and the like.

In some embodiments, a first cycle customer tray has a first cycle customer tray cell density, wherein a multi-cycle replacement tray has a higher cell density than the first cycle customer tray cell density. In other embodiments, a first cycle customer tray has a first cycle customer tray cell density, and the multi-cycle replacement tray has a cell density that is at least three times that of the first cycle customer tray cell density. In another embodiment, a second cycle customer tray has a second cycle customer tray cell density, and wherein a multi-cycle replacement tray has a higher cell density than the second cycle customer tray cell density. In other embodiments, a second cycle customer tray has a second cycle customer tray cell density, and the multi-cycle replacement tray has a cell density that is at least three times that of the second cycle customer tray cell density. In other embodiments, a multi-cycle replacement tray cell, may have the replacement tray has a higher cell density than said customer tray cell density. In other embodiments, the replacement tray cell density and the customer tray cell density may have a cell density ratio of at least two to one, and in some embodiments the cell density ratio may be at least three to one.

In some embodiments at least one computer stored, multi-cycle replacement tray maximization metric program may be any metric such as but not limited to a grow environment humidity metric, a storage environment humidity metric, a soil type metric, a feedwater flow rate metric, a weekly demand metric, a germination rate of customer tray metric, a germination rate of donor tray metric, a number of plants in inventory metric, a seed quality factor as variance in germination metric, a donor tray plants required metric, a risk factor metric, a future weeks required for donor tray plants metric, a total demand for donor propagules metric, a consumer tray time under light metric, a donor tray time under light metric, a donor tray time under storage metric, a donor tray cold storage time metric.

In some embodiments, it may be beneficial to utilize a reduced replacement parameter that may be a root ball volume ratio or have a replacement tray root ball volume being at least two times smaller than a customer tray root ball volume. In other embodiments the root ball volume ratio may be transplant tray to customer tray root ball volume and may be 1:2, 1:3, or 1:4. In some embodiments it may also be beneficial to utilize a multi growth stage parameterized metric program that may be a root ball volume ratio metric or have a replacement tray root ball volume being at least two times smaller than a customer tray root ball volume metric.

In some embodiments, it may be beneficial to utilize a multi-cycle replacement tray maximization metric that may be a root ball volume ratio or have a replacement tray root ball volume being at least two times smaller than a customer tray root ball volume. In other embodiments the root ball volume ratio may be transplant tray to customer tray root ball volume and may be 1:2, 1:3, or 1:4. In some embodiments it may also be beneficial to utilize a multi-cycle replacement tray maximization metric program that may be a root ball volume ratio metric or have a replacement tray root ball volume being at least two times smaller than a customer tray root ball volume metric.

In some embodiments, it may be beneficial to further include an input module to which the automated, computer implemented efficient plant order fulfillment system is responsive. In some embodiments, an input module may be an external operator input, an automated computer input, or the like. In some embodiments, a first cycle customer tray automated propagule punch system and a second cycle customer tray automated propagule punch system each may be an automatically directed propagule punch system, an operator activated propagule punch system, a computer directed propagule punch system, or the like. In some embodiments, at least one computer stored, multi-cycle replacement tray maximization metric program may be a future projection of transplant propagule need metric. In some embodiments, a future projection of transplant propagule need metric may be a 100 percent or near 100 percent (perhaps within 10 or other percent) customer order fulfillment metric.

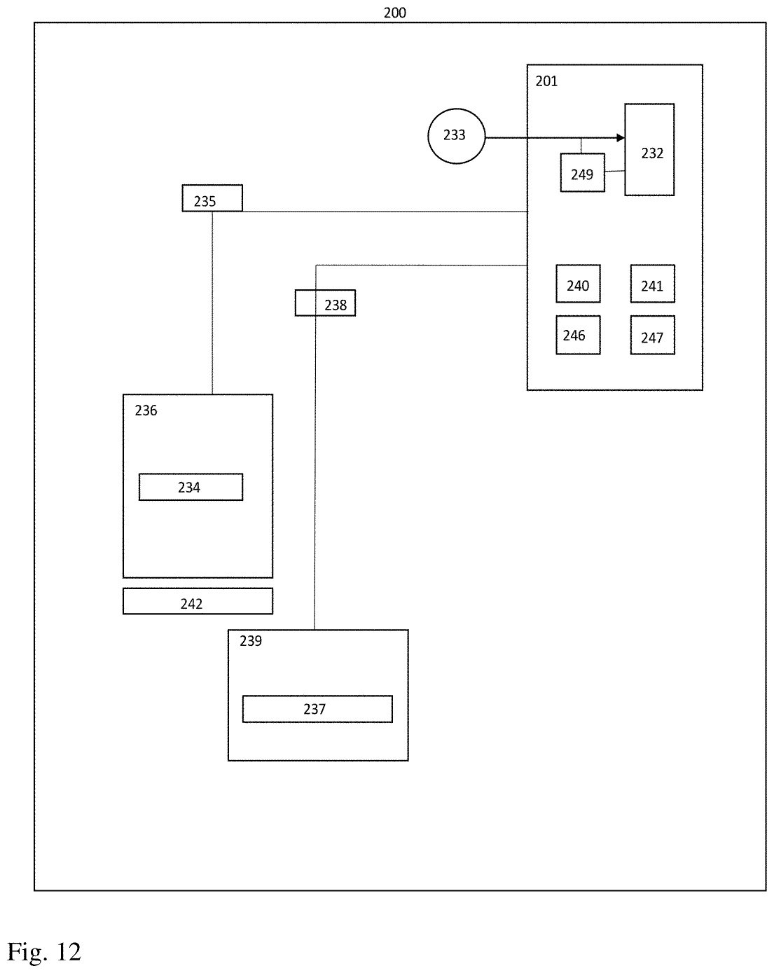

FIG. 12 is another exemplary embodiment of an automated, computer implemented efficient plant order fulfillment system. In some embodiments, it may be beneficial to include an automated, computer implemented efficient plant order fulfillment system. In some embodiments, an automated, computer implemented efficient plant order fulfillment system may include but is not limited to a programmable plant growth configured computer system (200); at least one computer stored, multi growth stage parameterized metric program stored in a programmable plant growth configured computer system, wherein said at least one computer stored, multi growth stage parameterized metric program includes parameters based on prior propagule growth information, and includes quantitative plant multi-growth stage parameterized horticultural growth relationships (232); a future customer tray need requirement input for a programmable plant growth configured computer system, and that interfaces with at least one computer stored, multi growth stage parameterized metric program (233); a customer tray having a plurality of propagules (234); a replacement tray having a plurality of donor propagules (237); a reduced replacement parameter calculator responsive to at least one computer stored, multi growth stage parameterized metric program, and to a future customer tray need requirement input (249); and a customer tray automated propagule punch system configured to act on a customer tray, and responsive to a reduced replacement parameter calculator (242).

In some embodiments, it may be beneficial to utilize at least one computer stored, multi growth stage parameterized metric program as at least one yield maximization metric program. In some embodiments, at least one yield maximization metric program may be a matrix or algorithm using varying quantitative metrics related to plant growth such as but not limited to propagule grow environment humidity, storage environment humidity, soil type, feedwater flow rate, the weekly or cycle demand, germination rate of customer tray, germination rate of donor tray, the number of plants in inventory, the seed quality factor as variance in germination, donor plants required, the qualified risk factor or risk factor, the number of future weeks required for donor plants, total demand for donor plants, consumer plant time under light, donor plant time under light, donor/replacement tray time under storage, donor/replacement tray and plant cold storage time, or the like. In some embodiments, an automated, computer implemented efficient plant order fulfillment system may further include a replacement need acceptance subroutine stored in said programmable plant growth configured computer system. In some embodiments, a replacement need acceptance subroutine may be an operator visual detection input subroutine. In other embodiments, a replacement need acceptance subroutine comprises a computer image detection subroutine.

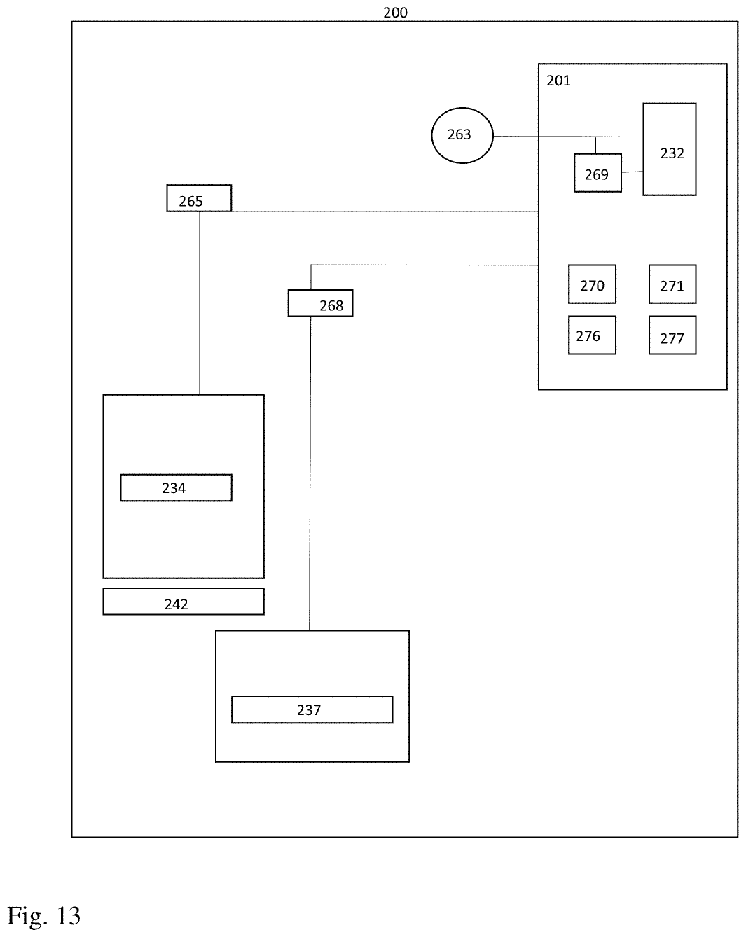

FIG. 13 is another exemplary embodiment of an automated, computer implemented, efficient plant order fulfillment system. In some embodiments, it may be beneficial to include an automated, computer implemented efficient plant order fulfillment system. In some embodiments, an automated, computer implemented efficient plant order fulfillment system may include but is not limited to a programmable plant growth configured computer system (200); at least one computer stored, multi growth stage parameterized metric program stored in a programmable plant growth configured computer system, wherein at least one computer stored, multi growth stage parameterized metric program includes parameters based on prior propagule growth information, and includes quantitative plant multi-growth stage parameterized horticultural growth relationships (232); an order fulfillment production yield requirement input for a programmable plant growth configured computer system, and that interfaces with at least one computer stored, multi growth stage parameterized metric program (263); a customer tray having a plurality of propagules (234); a replacement tray having a plurality of donor propagules (237); an order fulfillment production yield optimization subroutine stored in a programmable plant growth configured computer system and responsive to at least one computer stored, multi growth stage parameterized metric program, and to said order fulfillment production yield requirement input (269); a customer tray automated propagule punch system configured to act on a customer tray, and responsive to said order fulfillment production yield optimization subroutine (242).

In some embodiments, an order fulfillment production yield optimization subroutine may be at least 90, 95, 99, or 100 percent (perhaps plus or minus 0.2%, 0.5%, 1%, or 2%) order fulfillment production yield optimization subroutine. In other embodiments, an order fulfillment production yield optimization subroutine may be an economic waste optimization subroutine, a donor propagule waste optimization subroutine, a transplant propagule yield to waste propagule ratio optimization subroutine, a transplant propagule yield to customer propagule ratio optimization subroutine, or the like. In some embodiments, an order fulfillment production yield requirement may be a value such as the total number of plants/propagules needed to meet the customer order or other similar factors.

In some embodiments, a multi growth stage parameterized metric program may be any metric such as but not limited to a grow environment humidity metric, a storage environment humidity metric, a soil type metric, a feedwater flow rate metric, a weekly demand metric, a germination rate of customer tray metric, a germination rate of donor tray metric, a number of plants in inventory metric, a seed quality factor as variance in germination metric, a donor plants required metric, a risk factor metric, a future weeks required for donor plants metric, a total demand for donor propagules metric, a consumer tray time under light metric, a donor tray time under light metric, a donor tray time under storage metric, a donor tray cold storage time metric. In other embodiments, a replacement tray cell density, where the customer tray has a customer tray cell density, may have the replacement tray has a higher cell density than said customer tray cell density. In other embodiments, the replacement tray cell density and the customer tray cell density may have a cell density ratio of at least two to one, and in some embodiments, the cell density ratio may be at least three to one.

In some embodiments, it may be beneficial to further include an input module to which the programmable plant growth configured computer system is responsive. In some embodiments, the input module may be an external operator input, an automated computer input, or the like. In some embodiments the customer tray automated propagule punch system may be an automatically directed propagule punch system, an operator activated propagule punch system, a computer directed propagule punch system, or the like. In other embodiments, a multi growth stage parameterized metric program may be a future projection of transplant propagule need metric. In some embodiments, a future projection of transplant propagule need metric may be a 100 percent or near 100 percent (within 10 percent or otherwise) customer order fulfillment metric.

In some embodiments, it may be beneficial to include an automated, computer implemented efficient plant order fulfillment system. This system may include a programmable plant growth configured computer system; a customer tray having a plurality of propagules; a replacement tray having a plurality of donor propagules; an at least partly simultaneous, differential donor growth environment control having an operator interface with the programmable plant growth configured computer system; a donor growth environment responsive to at least partly simultaneous, differential donor growth environment control and configured to accommodate a donor replacement tray; and a customer tray automated propagule punch system configured to act on the customer tray.

In some embodiments, at least partly simultaneous, differential donor growth environment control may be a metrically controlled plant growth parameter control responsive to a customer tray propagule need as metrically determined. In some embodiments, a metrically controlled plant growth parameter may be any plant growth metric such as time, temperature, cost, or the like. In some embodiments metrically controlled plant growth parameter control may be a multi growth stage parameterized metric program stored in said programmable plant growth configured computer system, wherein said multi growth stage parameterized metric program includes parameters based on prior propagule growth information, and includes quantitative plant multi-growth stage parameterized horticultural growth relationships.

In some embodiments, it may be beneficial to provide a method of cultivation plants to maximize order fulfillment. In some embodiments, this may be accomplished by but is not limited to determining at least one yield maximizing metric; utilizing at least one yield maximizing metric to configure metrically controlled processes to replace a customer tray propagule; calculating customer tray propagule need compositely with at least one yield maximizing metric; primarily growing a customer tray propagule; secondarily growing a replacement tray propagule based on the metrically controlled processes compositely with the customer tray propagule need; transplanting a damaged customer tray propagule with said replacement tray propagule; and achieving maximize order fulfillment production yield which is statistically increased over a traditional transplant production period. In other embodiments, additional steps may be added and, in some embodiments, steps may be removed.

In some embodiments it may be beneficial to provide a method of cultivating plants to automatically maximize order fulfillment. In some embodiments this may be accomplished by but is not limited to determining at least one yield maximizing metric; utilizing at least one yield maximizing metric to configure metrically controlled processes to replace a customer tray propagule; calculating customer tray propagule need compositely with at least one yield maximizing metric; interfacing at least one yield maximizing metric with an input module; inputting at least one yield maximizing metric to an input module; primarily growing a customer tray propagule; secondarily growing a replacement tray propagule based on the metrically controlled processes compositely with the customer tray propagule need; transplanting a damaged customer tray propagule with the replacement tray propagule; and achieving maximize order fulfillment production yield which is statistically increased over a traditional transplant production period.

In some embodiments, it may be beneficial to provide a method of cultivating plants to optimize growth economics. In some embodiments, this may be accomplished by but is not limited to determining at least one yield maximizing metric for transplanting propagules; utilizing at least one yield maximizing metric for transplanting propagules in a donor matrix configured and arranged to calculate an optimal time and a future propagule requirement; calculating the optimal time and the future propagule requirement to optimize transplant efficiencies; and reducing transplant propagule waste through optimized transplant efficiencies.

In some embodiments, utilizing efficient transplanting with a smaller root ball may be achieved. A transplanting device may remove a small root ball propagule from a high cell density tray. Any type of transplanting system may be used, such as punching, robotic automation, or a mixture of human and robotic processes. In some embodiments, it may be beneficial to utilize a transplanting device to transplant the smaller root ball into a lower cell density tray. Transplanting may occur from a smaller cell size tray to an equal or larger size cell tray while the donor plant being transplanted remains an equal or similar size to the customer or growth tray plant.

In some embodiments, various cell size growing trays may be utilized. Trays that have varying cell densities may be utilized. In some embodiments, the upper tray may have a larger cell size than the lower tray, which has a smaller cell size. In some embodiments, a donor tray may be equal in cell size or soil volume to the customer tray, and in other embodiments, may be lesser than the customer tray. These figures represent a donor tray having a smaller cell size than the larger cell. In some embodiments, transplanting from the donor tray to the customer tray may take place when the customer plants grow to the size of the donor plants. The donor tray may be stored at this optimal size for a period of time until the next customer tray is grown to the optimal size.

While the present invention has been described in connection with some preferred embodiments, it is not intended to limit the scope of the invention to the particular form set forth, but on the contrary, it is intended to cover such alternatives, modifications, and equivalents, as may be included within the spirit and scope of the invention as defined by the statements of inventions. Examples of alternative claims may include:

1. A method of cultivating plants for efficient order fulfillment comprising the steps of:
utilizing prior propagule growth information to quantitatively develop multi-cycle horticultural growth relationships;
developing at least one multi-cycle replacement tray maximization metric;
programming said multi-cycle replacement tray maximization metric for automated operation by a programmable plant growth configured computer system;
determining the multi-cycle future propagule order fulfillment requirement;
inputting said multi-cycle future propagule order fulfillment requirement into said multi-cycle replacement tray maximization metric for automated operation in said programmable plant growth configured computer system;
primarily growing a first cycle customer tray having a plurality of propagules as automatically provided for a program implemented to utilize said at least one multi-cycle replacement tray maximization metric in said programmable plant growth configured computer system;
at least part simultaneously differentially growing a multi-cycle replacement tray based on said multi-cycle future propagule order fulfillment requirement and said at least one multi-cycle replacement tray maximization metric as automatically indicated by said program to optimize multi-cycle replacement tray maximization metric in said programmable plant growth configured computer system;
first programmable plant growth configured computer system accepting a valid replacement need;
first indicating a transplant on said programmable plant growth configured computer system as a result of said step of automatically providing for a program implemented to utilize said at least one multi-cycle replacement tray maximization metric in said programmable plant growth configured computer system
transplanting a multi-cycle replacement tray propagule from said multi-cycle replacement tray to replace a defective first cycle customer tray propagule in said first cycle customer tray through use of an automated propagule punch system;
primarily growing a second cycle customer tray having a plurality of second cycle customer tray propagules as automatically provided for a program implemented to utilize said at least one multi-cycle replacement tray maximization metric in said programmable plant growth configured computer system;
second programmable plant growth configured computer system accepting a valid replacement need;
second indicating a transplant on said programmable plant growth configured computer system as a result of said step of automatically providing for a program implemented to utilize said at least one multi-cycle replacement tray maximization metric in said programmable plant growth configured computer system; and
transplanting a multi-cycle replacement tray propagule from said multi-cycle replacement tray to replace a defective second cycle customer tray propagule through use of said automated propagule punch system.
   2. A method of cultivating plants for efficient order fulfillment as described in clause 1, or any other clause, wherein at least part simultaneously differentially growing a multi-cycle replacement tray based on said multi-cycle future propagule order fulfillment requirement and said at least one multi-cycle replacement tray maximization metric comprises secondarily differentially growing a multi-cycle replacement tray based on said multi-cycle future propagule order fulfillment requirement.
   3. A method of cultivating plants for efficient order fulfillment as described in clause 1, or any other clause, wherein said multi-cycle replacement tray comprises a higher cell density multi-cycle replacement tray than said first cycle customer tray, having a first cycle customer tray cell density.
   4. A method of cultivating plants for efficient order fulfillment as described in clause 1, or any other clause, wherein said multi-cycle replacement tray comprises a multi-cycle replacement tray cell density at least three times that of said first cycle customer tray, having a first cycle customer tray cell density.
   5. A method of cultivating plants for efficient order fulfillment as described in clause 1, or any other clause, wherein said multi-cycle replacement tray comprises a higher cell density multi-cycle replacement tray than said second cycle customer tray, having a second cycle customer tray cell density cell density.
   6. A method of cultivating plants for efficient order fulfillment as described in clause 1, or any other clause, wherein said multi-cycle replacement tray comprises a multi-cycle replacement tray cell density at least three times that of said second cycle customer tray, having a second cycle customer tray cell density cell density.
   7. A method of cultivating plants for efficient order fulfillment as described in clause 1, or any other clause, wherein transplanting a multi-cycle replacement tray propagule from said multi-cycle replacement tray to replace a defective first cycle customer tray propagule in said first cycle customer tray through use of an automated propagule punch system comprises automatically replacing at least one replacement tray propagule with an automated propagule punch system.
   8. A method of cultivating plants for efficient order fulfillment as described in clause 7, or any other clause, wherein said automated plant punching system comprises an artificially intelligent plant punching system.
   9. A method of cultivating plants for efficient order fulfillment as described in clause 1, or any other clause, wherein said at least one multi-cycle replacement tray maximization metric comprises a future projection of transplant propagule need metric.
   10. A method of cultivating plants for efficient order fulfillment as described in clause 10, or any other clause, wherein said future projection of transplant propagule need comprises a 100 percent customer order fulfillment metric.
   11. A method of cultivating plants for efficient order fulfillment comprising the steps of:
utilizing prior propagule growth information to quantitatively develop multi-cycle horticultural growth relationships;
determining at least one multi growth stage parameterized metric;
programming said multi growth stage parameterized metric for automated operation by a programmable plant growth configured computer system;
utilizing said at least one multi growth stage parameterized metric to configure a reduced replacement metrically controlled process to replace a customer tray propagule;
calculating a reduced replacement parameter based on a future customer tray propagule need; and
inputting said at least one multi growth stage parameterized metric into said reduced replacement metrically controlled process for automated operation in said programmable plant growth configured computer system;
replacing at least one customer tray propagule with an automated plant punching system;
utilizing said reduced replacement parameter to maximally fulfill said future customer tray propagule need.
   12. A method of cultivating plants for efficient order fulfillment as described in clause 11, or any other clause, further comprising compositely calculating said reduced replacement parameter with said at least one yield maximization metric.
   13. A method of cultivating plants for efficient order fulfillment as described in clause 11, or any other clause, wherein said metrically controlled process comprises operator visual detection.
   14. A method of cultivating plants for efficient order fulfillment as described in clause 11 wherein said metrically controlled process comprises computer detection.
   15. A method of cultivating plants for efficient order fulfillment as described in clause 11, or any other clause, wherein said multi growth stage parameterized metric comprises a weekly demand metric.
   16. A method of cultivating plants for efficient order fulfillment as described in clause 11, or any other clause, wherein said multi growth stage parameterized metric comprises a germination rate of customer tray metric.
   17. A method of cultivating plants for efficient order fulfillment as described in clause 11, or any other clause, wherein said multi growth stage parameterized metric comprises a germination rate of donor tray metric.
   18. A method of cultivating plants for efficient order fulfillment as described in clause 11, or any other clause, wherein said multi growth stage parameterized metric comprises a number of plants in inventory metric.
   19. A method of cultivating plants for efficient order fulfillment comprising the steps of:
utilizing prior propagule growth information to quantitatively develop multi-cycle horticultural growth relationships;
determining a multi growth stage parameterized metric;
programming said multi growth stage parameterized metric for automated operation by a programmable plant growth configured computer system;
utilizing said multi growth stage parameterized metric to configure metrically controlled processes to optimize order fulfillment production yield;
inputting said at least one multi growth stage parameterized metric into said reduced replacement metrically controlled process to optimize order fulfillment production yield for automated operation in said programmable plant growth configured computer system;
replacing at least one customer tray propagule with an automated plant punching system; and
achieving a metrically optimized order fulfillment production yield which is statistically optimized as compared to a traditional transplant production yield.
   20. A method of cultivating plants for efficient order fulfillment as described in clause 19, or any other clause, wherein achieving a metrically optimized order fulfillment production yield comprises at least 90 percent order fulfillment.
   21. A method of cultivating plants for efficient order fulfillment as described in clause 19, or any other clause, wherein achieving a metrically optimized order fulfillment production yield comprises at least 95 percent order fulfillment.
   22. A method of cultivating plants for efficient order fulfillment as described in clause 19, or any other clause, wherein utilizing said multi growth stage parameterized metric to configure metrically controlled processes to optimize order fulfillment production yield comprises optimizing transplant propagule waste.
   23. A method of cultivating plants for efficient order fulfillment as described in clause 19, or any other clause, wherein achieving a metrically optimized order fulfillment production yield comprises 100 percent order fulfillment.
   24. A method of cultivating plants for efficient order fulfillment as described in clause 19, or any other clause, wherein achieving a metrically optimized order fulfillment production yield which is statistically optimized as compared to a traditional transplant production yield comprises optimizing a transplant propagule yield to customer propagule ratio.
   25. An automated, computer implemented efficient plant order fulfillment system comprising:
a programmable plant growth configured computer system;
at least one computer stored, multi-cycle replacement tray maximization metric program stored in said programmable plant growth configured computer system, or any other clause, wherein said at least one computer stored, multi-cycle replacement tray maximization metric program includes parameters based on prior propagule growth information, and includes quantitative plant multi-growth stage parameterized horticultural growth relationships;
a multi-cycle future propagule order fulfillment requirement input for said programmable plant growth configured computer system, and that interfaces with said at least one computer stored, multi-cycle replacement tray maximization metric program;
a first cycle customer tray having a plurality of propagules;
a first cycle customer tray primary growth environment control having an operator interface with said programmable plant growth configured computer system;
a first cycle customer primary growth environment configured to influence said first cycle customer tray, and to operate as automatically provided for a program implemented to utilize said at least one multi-cycle replacement tray maximization metric in said programmable plant growth configured computer system;
a multi-cycle replacement tray having a plurality of donor propagules;
an at least partly simultaneous, differential donor growth environment control having an operator interface with said programmable plant growth configured computer system;
a donor growth environment configured to operate as automatically provided for a program implemented to utilize said at least one multi-cycle replacement tray maximization metric in said programmable plant growth configured computer system;
a first cycle customer tray automated propagule punch system;
a second cycle customer tray having a plurality of propagules;
a second cycle customer tray primary growth environment control having an operator interface with said programmable plant growth configured computer system;
a second cycle customer primary growth environment configured to influence said second cycle customer tray, and to operate as automatically provided for a program implemented to utilize said at least one multi-cycle replacement tray maximization metric in said programmable plant growth configured computer system; and
a second cycle customer tray automated propagule punch system.
   26. An automated, computer implemented efficient plant order fulfillment system as described in clause 25, or any other clause, further comprising:
a first replacement need acceptance subroutine stored in said programmable plant growth configured computer system;
a first transplant indicator stored in said programmable plant growth configured computer system;
a second replacement need acceptance subroutine stored in said programmable plant growth configured computer system; and
a second transplant indicator stored in said programmable plant growth configured computer system.
   27. A method of cultivating plants for efficient order fulfillment comprising the steps of:
determining at least one multi growth stage parameterized metric;
utilizing said at least one multi growth stage parameterized metric to configure a reduced replacement metrically controlled process to replace a customer tray propagule;
calculating a reduced replacement parameter based on a future customer tray propagule need; and
utilizing said reduced replacement parameter to maximally fulfill said future customer tray propagule need.
   28. A method of cultivating plants for efficient order fulfillment as described in clause 27, or any other clause, further comprising compositely calculating said reduced replacement parameter with said at least one yield maximization metric.
   29. A method of cultivating plants for efficient order fulfillment as described in clause 27, or any other clause, wherein said metrically controlled process comprises inputting an operator visual detection.
   30. A method of cultivating plants for efficient order fulfillment as described in clause 27, or any other clause, wherein said metrically controlled process comprises inputting a computer image detection.
   31. A method of cultivating plants for efficient order fulfillment as described in clause 27, or any other clause, wherein said reduced replacement parameter comprises a propagule grow environment humidity.
   32. A method of cultivating plants for efficient order fulfillment as described in clause 27, or any other clause, wherein said reduced replacement parameter comprises a storage environment humidity.
   33. A method of cultivating plants for efficient order fulfillment as described in clause 27, or any other clause, wherein said reduced replacement parameter comprises a soil type.
   34. A method of cultivating plants for efficient order fulfillment as described in clause 27, or any other clause, wherein said reduced replacement parameter comprises a feedwater flow rate.
   35. A method of cultivating plants for efficient order fulfillment as described in clause 27, or any other clause, wherein said reduced replacement parameter comprises a weekly demand
   36. A method of cultivating plants for efficient order fulfillment as described in clause 27, or any other clause, wherein said reduced replacement parameter comprises a germination rate of customer tray.
   37. A method of cultivating plants for efficient order fulfillment as described in clause 27, or any other clause, wherein said reduced replacement parameter comprises a root ball volume ratio.
   38. A method of cultivating plants for efficient order fulfillment as described in clause 27, or any other clause, wherein said reduced replacement parameter comprises a replacement tray root ball volume being at least two times smaller than a customer tray root ball volume.
   39. A method of cultivating plants for efficient order fulfillment as described in clause 27, or any other clause, wherein said reduced replacement parameter comprises a germination rate of donor tray.
   40. A method of cultivating plants for efficient order fulfillment as described in clause 27, or any other clause, wherein said reduced replacement parameter comprises a number of plants in inventory.
   41. A method of cultivating plants for efficient order fulfillment as described in clause 27, or any other clause, wherein said reduced replacement parameter comprises a seed quality factor as variance in germination.
   42. A method of cultivating plants for efficient order fulfillment as described in clause 27, or any other clause, wherein said reduced replacement parameter comprises a donor plants required.
   43. A method of cultivating plants for efficient order fulfillment as described in clause 27, or any other clause, wherein said reduced replacement parameter comprises a risk factor.
   44. A method of cultivating plants for efficient order fulfillment as described in clause 27, or any other clause, wherein said reduced replacement parameter comprises a future weeks required for donor plants.
   45. A method of cultivating plants for efficient order fulfillment as described in clause 27, or any other clause, wherein said reduced replacement parameter comprises a total demand for donor propagules.
   46. A method of cultivating plants for efficient order fulfillment as described in clause 27, or any other clause, wherein said reduced replacement parameter comprises a consumer tray time under light.
   47. A method of cultivating plants for efficient order fulfillment as described in clause 27, or any other clause, wherein said reduced replacement parameter comprises a donor tray time under light.
   48. A method of cultivating plants for efficient order fulfillment as described in clause 27, or any other clause, wherein said reduced replacement parameter comprises a donor tray time under storage.
   49. A method of cultivating plants for efficient order fulfillment as described in clause 27, or any other clause, wherein said reduced replacement parameter comprises a donor tray cold storage time.
   50. An automated, computer implemented efficient plant order fulfillment system comprising:
a programmable plant growth configured computer system;
at least one computer stored, multi growth stage parameterized metric program stored in said programmable plant growth configured computer system, or any other clause, wherein said at least one computer stored, multi growth stage parameterized metric program includes parameters based on prior propagule growth information, and includes quantitative plant multi-growth stage parameterized horticultural growth relationships;
a future customer tray need requirement input for said programmable plant growth configured computer system, and that interfaces with said at least one computer stored, multi growth stage parameterized metric program;
a customer tray having a plurality of propagules;
a replacement tray having a plurality of donor propagules;
a reduced replacement parameter calculator responsive to said at least one computer stored, multi growth stage parameterized metric program, and to said future customer tray need requirement input; and
a customer tray automated propagule punch system configured to act on said customer tray, and responsive to said reduced replacement parameter calculator.
   51. An automated, computer implemented efficient plant order fulfillment system as described in clause 50, or any other clause, wherein said at least one computer stored, multi growth stage parameterized metric program comprises at least one yield maximization metric program.
   52. An automated, computer implemented efficient plant order fulfillment system as described in clause ______ and, or any other clause, further comprising a replacement need acceptance subroutine stored in said programmable plant growth configured computer system.
   53. An automated, computer implemented efficient plant order fulfillment system as described in clause 50, or any other clause, wherein said replacement need acceptance subroutine comprises an operator visual detection input subroutine.
   54. An automated, computer implemented efficient plant order fulfillment system as described in clause 50, or any other clause, wherein said replacement need acceptance subroutine comprises a computer image detection subroutine.
   55. An automated, computer implemented efficient plant order fulfillment system as described in clause 50, or any other clause, wherein said multi growth stage parameterized metric program comprises a grow environment humidity metric.
   56. An automated, computer implemented efficient plant order fulfillment system as described in clause 50, or any other clause, wherein said multi growth stage parameterized metric program comprises a storage environment humidity metric.
   57. An automated, computer implemented efficient plant order fulfillment system as described in clause 50, or any other clause, wherein said multi growth stage parameterized metric program comprises a soil type metric.
   58. An automated, computer implemented efficient plant order fulfillment system as described in clause 50, or any other clause, wherein said multi growth stage parameterized metric program comprises a feedwater flow rate metric.
   59. An automated, computer implemented efficient plant order fulfillment system as described in clause 50, or any other clause, wherein said multi growth stage parameterized metric program comprises a root ball volume ratio metric.
   60. An automated, computer implemented efficient plant order fulfillment system as described in clause 50, or any other clause, wherein said multi growth stage parameterized metric program comprises a replacement tray root ball volume being at least two times smaller than a customer tray root ball volume metric.
   61. An automated, computer implemented efficient plant order fulfillment system as described in clause 50, or any other clause, wherein said multi growth stage parameterized metric program comprises a germination rate of customer tray metric.
   62. An automated, computer implemented efficient plant order fulfillment system as described in clause 50, or any other clause, wherein said multi growth stage parameterized metric program comprises a germination rate of donor tray metric.
   63. An automated, computer implemented efficient plant order fulfillment system as described in clause 50, or any other clause, wherein said multi growth stage parameterized metric program comprises a number of plants in inventory metric.
   64. An automated, computer implemented efficient plant order fulfillment system as described in clause 50, or any other clause, wherein said multi growth stage parameterized metric program comprises a seed quality factor as variance in germination metric.
   65. An automated, computer implemented efficient plant order fulfillment system as described in clause 50, or any other clause, wherein said multi growth stage parameterized metric program comprises a donor plants required metric.
   66. An automated, computer implemented efficient plant order fulfillment system as described in clause 50, or any other clause, wherein said multi growth stage parameterized metric program comprises a risk factor metric.
   67. An automated, computer implemented efficient plant order fulfillment system as described in clause 50, or any other clause, wherein said multi growth stage parameterized metric program comprises a future weeks required for donor plants metric.
   68. An automated, computer implemented efficient plant order fulfillment system as described in clause 50, or any other clause, wherein said multi growth stage parameterized metric program comprises a total demand for donor propagules metric.
   69. An automated, computer implemented efficient plant order fulfillment system as described in clause 50, or any other clause, wherein said multi growth stage parameterized metric program comprises a consumer tray time under light metric.
   70. An automated, computer implemented efficient plant order fulfillment system as described in clause 50, or any other clause, wherein said multi growth stage parameterized metric program comprises a donor tray time under light metric.
   71. An automated, computer implemented efficient plant order fulfillment system as described in clause 50, or any other clause, wherein said multi growth stage parameterized metric program comprises a donor tray time under storage metric.
   72. An automated, computer implemented efficient plant order fulfillment system as described in clause 50, or any other clause, wherein said multi growth stage parameterized metric program comprises a donor tray cold storage time metric.
   73. A method of cultivating plants for efficient order fulfillment comprising the steps of:
primarily growing at least one original customer tray having a plurality of propagules;
replacing at least one defective propagule of said plurality of propagules with a replacement tray propagule;
secondarily differentially growing said original customer tray having at least one propagule of said plurality of propagules and said replacement tray propagule.
   74. A method of cultivating plants for efficient order fulfillment comprising as described in 73, or any other clause, wherein differentially growing said original customer tray having at least one propagule of said plurality of propagules and said replacement tray propagule comprises growing a replacement tray propagule based on a metrically controlled processes compositely with a customer tray propagule need.
   75. A method of cultivating plants for efficient order fulfillment comprising as described in 74, or any other clause, wherein said growing a replacement tray propagule based on a metrically controlled processes compositely with a customer tray propagule need comprises utilizing a at least one multi growth stage parameterized metric.
   76. A method of cultivating plants for efficient order fulfillment as described in clause 73, or any other clause, wherein said at least one multi growth stage parameterized metric comprises a propagule grow environment humidity metric.
   77. A method of cultivating plants for efficient order fulfillment as described in clause 73, or any other clause, wherein said at least one multi growth stage parameterized metric comprises a storage environment humidity.
   78. A method of cultivating plants for efficient order fulfillment as described in clause 73, or any other clause, wherein said at least one multi growth stage parameterized metric comprises a soil type metric.
   79. A method of cultivating plants for efficient order fulfillment as described in clause 73, or any other clause, wherein said at least one multi growth stage parameterized metric comprises a feedwater flow rate metric.
   80. A method of cultivating plants for efficient order fulfillment as described in clause 73, or any other clause, wherein said at least one multi growth stage parameterized metric comprises a weekly demand metric.
   81. A method of cultivating plants for efficient order fulfillment as described in clause 73, or any other clause, wherein said at least one multi growth stage parameterized metric comprises a germination rate of customer tray metric.
   82. A method of cultivating plants for efficient order fulfillment as described in clause 73, or any other clause, wherein said at least one multi growth stage parameterized metric comprises a germination rate of donor tray metric.
   83. A method of cultivating plants for efficient order fulfillment as described in clause 73, or any other clause, wherein said at least one multi growth stage parameterized metric comprises a number of plants in inventory metric.
   84. A method of cultivating plants for efficient order fulfillment as described in clause 73, or any other clause, wherein said at least one multi growth stage parameterized metric comprises a seed quality factor as variance in germination metric.
   85. A method of cultivating plants for efficient order fulfillment as described in clause 73, or any other clause, wherein said at least one multi growth stage parameterized metric comprises a donor plants required.
   86. A method of cultivating plants for efficient order fulfillment as described in clause 73, or any other clause, wherein said at least one multi growth stage parameterized metric comprises a risk factor.
   87. A method of cultivating plants for efficient order fulfillment as described in clause 73, or any other clause, wherein said at least one multi growth stage parameterized metric comprises a future weeks required for donor plants.
   88. A method of cultivating plants for efficient order fulfillment as described in clause 73, or any other clause, wherein said at least one multi growth stage parameterized metric comprises a total demand for donor propagule metric.
   89. A method of cultivating plants for efficient order fulfillment as described in clause 73, or any other clause, wherein said at least one multi growth stage parameterized metric comprises a consumer tray time under light.
   90. A method of cultivating plants for efficient order fulfillment as described in clause 73, or any other clause, wherein said at least one multi growth stage parameterized metric comprises a donor tray time under light.
   91. A method of cultivating plants for efficient order fulfillment as described in clause 73, or any other clause, wherein said at least one multi growth stage parameterized metric comprises a donor tray time under storage.
   92. A method of cultivating plants for efficient order fulfillment as described in clause 73, or any other clause, wherein said at least one multi growth stage parameterized metric comprises a donor tray cold storage time.
   93. A method of cultivating plants for efficient order fulfillment as described in clause 73, or any other clause, wherein said multi growth stage parameterized metric comprises a root ball volume ratio.
   94. A method of cultivating plants for efficient order fulfillment as described in clause 73, or any other clause, wherein said multi growth stage parameterized metric comprises a replacement tray root ball volume being at least two times smaller than a customer tray root ball volume.
   95. A method of cultivating plants for efficient order fulfillment as described in clause 73, or any other clause, wherein said replacement tray comprises a replacement tray with a higher propagule cell density than a customer tray having a customer tray cell density.
   96. A method of cultivating plants for efficient order fulfillment as described in clause 95, or any other clause, wherein said replacement tray has a higher propagule cell density than a cell density of a customer tray comprises a cell density ratio of at least two to one.
   97. A method of cultivating plants for efficient order fulfillment as described in clause 95, or any other clause, wherein said replacement tray with a higher propagule cell density than a cell density of a customer tray comprises a cell density ratio of at least three to one.
   98. A method of cultivating plants for efficient order fulfillment as described in clause 73 and, or any other clause, further comprising the step of interfacing with an input module.
   99. A method of cultivating plants for efficient order fulfillment as described in clause 98, or any other clause, wherein said input module comprises an operator.
   100. A method of cultivating plants for efficient order fulfillment as described in clause 98, or any other clause, wherein said input module a central processing unit.
   101. A method of cultivating plants for efficient order fulfillment as described in clause 73, or any other clause, wherein said replacement tray propagule comprises an automatic replacement of a replacement tray propagule through the use of an automated plant punching system.
   102. A method of cultivating plants for efficient order fulfillment as described in clause 101, or any other clause, wherein said automatic replacement of a replacement tray propagule comprises an external operator plant punching system.
   103. A method of cultivating plants for efficient order fulfillment as described in clause 101, or any other clause, wherein said plant punching system comprises an artificially intelligent computer directed plant punching system.
   104. A method of cultivating plants for efficient order fulfillment as described in clause 73, or any other clause, wherein said yield optimization metric comprises future projection of transplant propagule need.
   105. A method of cultivating plants for efficient order fulfillment as described in clause 104, or any other clause, wherein said future projection of transplant propagule need comprises 100 percent customer order fulfillment.
   106. An automated, computer implemented efficient plant order fulfillment system comprising:
a programmable plant growth configured computer system;
a customer tray having a plurality of propagules;
a replacement tray having a plurality of donor propagules;
an at least partly simultaneous, differential donor growth environment control having an operator interface with said programmable plant growth configured computer system;
a donor growth environment responsive to said at least partly simultaneous, differential donor growth environment control and configured to accommodate said donor replacement tray; and
a customer tray automated propagule punch system configured to act on said customer tray.
   107. An automated, computer implemented efficient plant order fulfillment system as described in clause 106, or any other clause, wherein said at least partly simultaneous, differential donor growth environment control comprises a metrically controlled plant growth parameter control responsive to a customer tray propagule need.
   108. An automated, computer implemented efficient plant order fulfillment system as described in clause 107, or any other clause, wherein said metrically controlled plant growth parameter control comprises a multi growth stage parameterized metric program stored in said programmable plant growth configured computer system, or any other clause, wherein said multi growth stage parameterized metric program includes parameters based on prior propagule growth information, and includes quantitative plant multi-growth stage parameterized horticultural growth relationships.
   109. An automated, computer implemented efficient plant order fulfillment system as described in clause 106, or any other clause, wherein said multi growth stage parameterized metric program comprises a grow environment humidity metric.
   110. An automated, computer implemented efficient plant order fulfillment system as described in clause 106, or any other clause, wherein said multi growth stage parameterized metric program comprises a storage environment humidity metric.
   111. An automated, computer implemented efficient plant order fulfillment system as described in clause 106, or any other clause, wherein said multi growth stage parameterized metric program comprises a soil type metric.
   112. An automated, computer implemented efficient plant order fulfillment system as described in clause 106, or any other clause, wherein said multi growth stage parameterized metric program comprises a feedwater flow rate metric.
   113. An automated, computer implemented efficient plant order fulfillment system as described in clause 106, or any other clause, wherein said multi growth stage parameterized metric program comprises a weekly demand metric.
   114. An automated, computer implemented efficient plant order fulfillment system as described in clause 106, or any other clause, wherein said multi growth stage parameterized metric program comprises a germination rate of customer tray metric.
   115. An automated, computer implemented efficient plant order fulfillment system as described in clause 106, or any other clause, wherein said multi growth stage parameterized metric program comprises a germination rate of donor tray metric.
   116. An automated, computer implemented efficient plant order fulfillment system as described in clause 106, or any other clause, wherein said multi growth stage parameterized metric program comprises a number of plants in inventory metric.
   117. An automated, computer implemented efficient plant order fulfillment system as described in clause 106, or any other clause, wherein said multi growth stage parameterized metric program comprises a seed quality factor as variance in germination metric.
   118. An automated, computer implemented efficient plant order fulfillment system as described in clause 106, or any other clause, wherein said multi growth stage parameterized metric program comprises a donor plants required metric.
   119. An automated, computer implemented efficient plant order fulfillment system as described in clause 106, or any other clause, wherein said multi growth stage parameterized metric program comprises a risk factor metric.
   120. An automated, computer implemented efficient plant order fulfillment system as described in clause 106, or any other clause, wherein said multi growth stage parameterized metric program comprises a future weeks required for donor plants metric.
   121. An automated, computer implemented efficient plant order fulfillment system as described in clause 106, or any other clause, wherein said multi growth stage parameterized metric program comprises a total demand for donor propagules metric.
   122. An automated, computer implemented efficient plant order fulfillment system as described in clause 106, or any other clause, wherein said multi growth stage parameterized metric program comprises a consumer tray time under light metric.
   123. An automated, computer implemented efficient plant order fulfillment system as described in clause 106, or any other clause, wherein said multi growth stage parameterized metric program comprises a donor tray time under light metric.
   124. An automated, computer implemented efficient plant order fulfillment system as described in clause 106, or any other clause, wherein said multi growth stage parameterized metric program comprises a donor tray time under storage metric.
   125. An automated, computer implemented efficient plant order fulfillment system as described in clause 106, or any other clause, wherein said multi growth stage parameterized metric program comprises a donor tray cold storage time metric.
   126. An automated, computer implemented efficient plant order fulfillment system as described in clause 106, or any other clause, wherein said multi growth stage parameterized metric program comprises a root ball volume ratio metric.
   127. An automated, computer implemented efficient plant order fulfillment system as described in clause 106, or any other clause, wherein said multi growth stage parameterized metric program comprises a replacement tray root ball volume being at least two times smaller than a customer tray root ball volume metric.
   128. An automated, computer implemented efficient plant order fulfillment system as described in clause 106, or any other clause, wherein said replacement tray has a replacement tray cell density, said customer tray has a customer tray cell density, and, or any other clause, wherein said replacement tray has a higher cell density than said customer tray cell density.
   129. An automated, computer implemented efficient plant order fulfillment system as described in clause 128, or any other clause, wherein said replacement tray cell density and said customer tray cell density comprise a cell density ratio of at least two to one.
   130. An automated, computer implemented efficient plant order fulfillment system as described in clause 128, or any other clause, wherein said future week replacement tray cell density and said customer tray cell density comprise a cell density ratio of at least three to one.
   131. An automated, computer implemented efficient plant order fulfillment system as described in clause 106 and, or any other clause, further comprising an input module to which said programmable plant growth configured computer system is responsive.
   132. An automated, computer implemented efficient plant order fulfillment system as described in clause 131, or any other clause, wherein said input module comprises an external operator input.
   133. An automated, computer implemented efficient plant order fulfillment system as described in clause 131, or any other clause, wherein said input module comprises an automated computer input.
   134. An automated, computer implemented efficient plant order fulfillment system as described in clause 106, or any other clause, wherein said customer tray automated propagule punch system comprises an automatically directed propagule punch system.
   135. An automated, computer implemented efficient plant order fulfillment system as described in clause 106, or any other clause, wherein said customer tray automated propagule punch system comprises an operator activated propagule punch system.
   136. An automated, computer implemented efficient plant order fulfillment system as described in clause 106, or any other clause, wherein said customer tray automated propagule punch system comprises a computer directed propagule punch system.
   137. An automated, computer implemented efficient plant order fulfillment system as described in clause 106, or any other clause, wherein said multi growth stage parameterized metric program comprises a future projection of transplant propagule need metric.
   138. An automated, computer implemented efficient plant order fulfillment system as described in clause 137, or any other clause, wherein said future projection of transplant propagule need metric comprises 100 percent customer order fulfillment metric.
   139. A method of cultivating plants for efficient order fulfillment comprising the steps of:
determining a multi growth stage parameterized metric;
utilizing said multi growth stage parameterized metric to configure metrically controlled processes to optimize order fulfillment production yield;
metrically optimizing order fulfillment production yield; and
achieving a metrically optimized order fulfillment production yield which is statistically optimized as compared to a traditional transplant production yield.
   140. A method of cultivating plants for efficient order fulfillment production yield as described in clause 139, or any other clause, wherein metrically optimizing order fulfillment production yield comprises at least 90 percent order fulfillment.
   141. A method of cultivating plants for efficient order fulfillment production yield as described in clause 139, or any other clause, wherein metrically optimizing order fulfillment production yield comprises at least 95 percent order fulfillment.
   142. A method of cultivating plants for efficient order fulfillment production yield as described in clause 139, or any other clause, wherein metrically optimizing order fulfillment production yield comprises at least 99 percent order fulfillment.
   143. A method of cultivating plants for efficient order fulfillment as described in clause 139, or any other clause, wherein metrically optimizing order fulfillment production yield comprises 100 percent order fulfillment.
   144. A method of cultivating plants for efficient order fulfillment as described in clause 139, or any other clause, wherein utilizing said multi growth stage parameterized metric to configure metrically controlled processes to optimize order fulfillment production yield comprises optimizing economic waste.
   145. A method of cultivating plants for efficient order fulfillment as described in clause 139, or any other clause, wherein utilizing said multi growth stage parameterized metric to configure metrically controlled processes to optimize order fulfillment production yield comprises optimizing transplant propagule waste.
   146. A method of cultivating plants for efficient order fulfillment as described in clause 139, or any other clause, wherein achieving a metrically optimized order fulfillment production yield which is statistically optimized as compared to a traditional transplant production yield comprises optimizing a transplant propagule yield to waste propagule ratio.
   147. A method of cultivating plants for efficient order fulfillment as described in clause 139, or any other clause, wherein achieving a metrically optimized order fulfillment production yield which is statistically optimized as compared to a traditional transplant production yield comprises optimizing a transplant propagule yield to customer propagule ratio.
   148. A method of cultivating plants for efficient order fulfillment as described in clause 139, or any other clause, wherein said multi growth stage parameterized metric comprises propagule a grow environment humidity metric.
   149. A method of cultivating plants for efficient order fulfillment as described in clause 139, or any other clause, wherein said multi growth stage parameterized metric comprises a storage environment humidity metric.
   150. A method of cultivating plants for efficient order fulfillment as described in clause 139, or any other clause, wherein said multi growth stage parameterized metric comprises a soil type metric.
   151. A method of cultivating plants for efficient order fulfillment as described in clause 139, or any other clause, wherein said multi growth stage parameterized metric comprises a feedwater flow rate metric.
   152. A method of cultivating plants for efficient order fulfillment as described in clause 139, or any other clause, wherein said multi growth stage parameterized metric comprises a weekly demand metric.
   153. A method of cultivating plants for efficient order fulfillment as described in clause 139, or any other clause, wherein said multi growth stage parameterized metric comprises a germination rate of customer tray metric.
   154. A method of cultivating plants for efficient order fulfillment as described in clause 139, or any other clause, wherein said multi growth stage parameterized metric comprises a root ball volume ratio.
   155. A method of cultivating plants for efficient order fulfillment as described in clause 139, or any other clause, wherein said multi growth stage parameterized metric comprises a replacement tray root ball volume being at least two times smaller than a customer tray root ball volume.
   156. A method of cultivating plants for efficient order fulfillment as described in clause 139, or any other clause, wherein said multi growth stage parameterized metric comprises a germination rate of donor tray metric.
   157. A method of cultivating plants for efficient order fulfillment as described in clause 139, or any other clause, wherein said multi growth stage parameterized metric comprises a number of plants in inventory metric.
   158. A method of cultivating plants for efficient order fulfillment as described in clause 139, or any other clause, wherein said multi growth stage parameterized metric comprises a seed quality factor as variance in germination metric.
   159. A method of cultivating plants for efficient order fulfillment as described in clause 139, or any other clause, wherein said multi growth stage parameterized metric comprises a donor plants required metric.
   160. A method of cultivating plants for efficient order fulfillment as described in clause 139, or any other clause, wherein said multi growth stage parameterized metric comprises a risk factor metric.
   161. A method of cultivating plants for efficient order fulfillment as described in clause 139, or any other clause, wherein said multi growth stage parameterized metric comprises a future weeks required for donor plants metric.
   162. A method of cultivating plants for efficient order fulfillment as described in clause 139, or any other clause, wherein said multi growth stage parameterized metric comprises a total demand for donor propagule metric.
   163. A method of cultivating plants for efficient order fulfillment as described in clause 139, or any other clause, wherein said multi growth stage parameterized metric comprises a consumer tray time under light metric.
   164. A method of cultivating plants for efficient order fulfillment as described in clause 139, or any other clause, wherein said multi growth stage parameterized metric comprises a donor tray time under light metric.
   165. A method of cultivating plants for efficient order fulfillment as described in clause 139, or any other clause, wherein said multi growth stage parameterized metric comprises a donor tray time under storage metric.
   166. A method of cultivating plants for efficient order fulfillment as described in clause 139, or any other clause, wherein said multi growth stage parameterized metric comprises a donor tray cold storage time metric.
   167. A method of cultivating plants for efficient order fulfillment as described in clause 139, or any other clause, wherein said replacement tray comprises a replacement tray with a higher propagule cell density than a customer tray having a customer tray cell density
   168. A method of cultivating plants for efficient order fulfillment as described in clause 167, or any other clause, wherein said replacement tray has a higher propagule cell density than a cell density of a customer tray comprises a cell density ratio of at least two to one.
   169. A method of cultivating plants for efficient order fulfillment as described in clause 167, or any other clause, wherein said replacement tray with a higher propagule cell density than a cell density of a customer tray comprises a cell density ratio of at least three to one.
   170. A method of cultivating plants for efficient order fulfillment as described in clause 139 and, or any other clause, further comprising the step of interfacing with an input module.
   171. A method of cultivating plants for efficient order fulfillment as described in clause 170, or any other clause, wherein said input module comprises an operator input.
   172. A method of cultivating plants for efficient order fulfillment as described in clause 170, or any other clause, wherein said input module a central processing unit.
   173. A method of cultivating plants for efficient order fulfillment as described in clause 139, or any other clause, wherein said replacement tray propagule comprises an automatic replacement of a replacement tray propagule through the use of an automated plant punching system.
   174. A method of cultivating plants for efficient order fulfillment as described in clause 139, or any other clause, further comprising the step of interfacing with an input module.
   175. A method of cultivating plants for efficient order fulfillment as described in clause 139, or any other clause, wherein said input module comprises an external operator input.
   176. A method of cultivating plants for efficient order fulfillment as described in clause 173, or any other clause, wherein said plant punching system comprises an artificially intelligent computer propagule punching system.
   177. A method of cultivating plants for efficient order fulfillment as described in clause 139, or any other clause, wherein said yield optimization metric comprises future projection of transplant propagule need.
   178. A method of cultivating plants for efficient order fulfillment as described in clause 177, or any other clause, wherein said future projection of transplant propagule need comprises 100 percent customer order fulfillment.
   179. An automated, computer implemented efficient plant order fulfillment system comprising:
a programmable plant growth configured computer system;
at least one computer stored, multi growth stage parameterized metric program stored in said programmable plant growth configured computer system, or any other clause, wherein said at least one computer stored, multi growth stage parameterized metric program includes parameters based on prior propagule growth information, and includes quantitative plant multi-growth stage parameterized horticultural growth relationships;
an order fulfillment production yield requirement input for said programmable plant growth configured computer system, and that interfaces with said at least one computer stored, multi growth stage parameterized metric program;
a customer tray having a plurality of propagules;
a replacement tray having a plurality of donor propagules;
an order fulfillment production yield optimization subroutine stored in said programmable plant growth configured computer system and responsive to said at least one computer stored, multi growth stage parameterized metric program, and to said order fulfillment production yield requirement input; and
a customer tray automated propagule punch system configured to act on said customer tray, and responsive to said order fulfillment production yield optimization subroutine.
   180. An automated, computer implemented efficient plant order fulfillment system as described in clause 179, or any other clause, wherein said order fulfillment production yield optimization subroutine comprises an at least 90 percent order fulfillment production yield optimization subroutine.
   181. An automated, computer implemented efficient plant order fulfillment system as described in clause 179, or any other clause, wherein said order fulfillment production yield optimization subroutine comprises an at least 95 percent order fulfillment production yield optimization subroutine.
   182. An automated, computer implemented efficient plant order fulfillment system as described in clause 179, or any other clause, wherein said order fulfillment production yield optimization subroutine comprises an at least 99 percent order fulfillment production yield optimization subroutine.
   183. An automated, computer implemented efficient plant order fulfillment system as described in clause 179, or any other clause, wherein said order fulfillment production yield optimization subroutine comprises a 100 percent order fulfillment production yield optimization subroutine.
   184. An automated, computer implemented efficient plant order fulfillment system as described in clause 179, or any other clause, wherein said order fulfillment production yield optimization subroutine comprises an economic waste optimization subroutine.
   185. An automated, computer implemented efficient plant order fulfillment system as described in clause 179, or any other clause, wherein said order fulfillment production yield optimization subroutine comprises a donor propagule waste optimization subroutine.
   186. An automated, computer implemented efficient plant order fulfillment system as described in clause 179, or any other clause, wherein said order fulfillment production yield optimization subroutine comprises a transplant propagule yield to waste propagule ratio optimization subroutine.
   187. An automated, computer implemented efficient plant order fulfillment system as described in clause 179, or any other clause, wherein said order fulfillment production yield optimization subroutine comprises a transplant propagule yield to customer propagule ratio optimization subroutine.
   188. An automated, computer implemented efficient plant order fulfillment system as described in clause 179, or any other clause, wherein said multi growth stage parameterized metric program comprises a grow environment humidity metric.
   189. An automated, computer implemented efficient plant order fulfillment system as described in clause 179, or any other clause, wherein said multi growth stage parameterized metric program comprises a storage environment humidity metric.
   190. An automated, computer implemented efficient plant order fulfillment system as described in clause 179, or any other clause, wherein said multi growth stage parameterized metric program comprises a soil type metric.
   191. An automated, computer implemented efficient plant order fulfillment system as described in clause 179, or any other clause, wherein said multi growth stage parameterized metric program comprises a feedwater flow rate metric.
   192. An automated, computer implemented efficient plant order fulfillment system as described in clause 179, or any other clause, wherein said multi growth stage parameterized metric program comprises a weekly demand metric.
   193. An automated, computer implemented efficient plant order fulfillment system as described in clause 179, or any other clause, wherein said multi growth stage parameterized metric program comprises a germination rate of customer tray metric.
   194. An automated, computer implemented efficient plant order fulfillment system as described in clause 179, or any other clause, wherein said multi growth stage parameterized metric program comprises a root ball volume ratio metric.
   195. An automated, computer implemented efficient plant order fulfillment system as described in clause 179, or any other clause, wherein said multi growth stage parameterized metric program comprises a replacement tray root ball volume being at least two times smaller than a customer tray root ball volume metric.
   196. An automated, computer implemented efficient plant order fulfillment system as described in clause 179, or any other clause, wherein said multi growth stage parameterized metric program comprises a germination rate of donor tray metric.
   197. An automated, computer implemented efficient plant order fulfillment system as described in clause 179, or any other clause, wherein said multi growth stage parameterized metric program comprises a number of plants in inventory metric.
   198. An automated, computer implemented efficient plant order fulfillment system as described in clause 179, or any other clause, wherein said multi growth stage parameterized metric program comprises a seed quality factor as variance in germination metric.
   199. An automated, computer implemented efficient plant order fulfillment system as described in clause 179, or any other clause, wherein said multi growth stage parameterized metric program comprises a donor plants required metric.
   200. An automated, computer implemented efficient plant order fulfillment system as described in clause 179, or any other clause, wherein said multi growth stage parameterized metric program comprises a risk factor metric.
   201. An automated, computer implemented efficient plant order fulfillment system as described in clause 179, or any other clause, wherein said multi growth stage parameterized metric program comprises a future weeks required for donor plants metric.
   202. An automated, computer implemented efficient plant order fulfillment system as described in clause 179, or any other clause, wherein said multi growth stage parameterized metric program comprises a total demand for donor propagules metric.
   203. An automated, computer implemented efficient plant order fulfillment system as described in clause 179, or any other clause, wherein said multi growth stage parameterized metric program comprises a consumer tray time under light metric.
   204. An automated, computer implemented efficient plant order fulfillment system as described in clause 179, or any other clause, wherein said multi growth stage parameterized metric program comprises a donor tray time under light metric.
   205. An automated, computer implemented efficient plant order fulfillment system as described in clause 179, or any other clause, wherein said multi growth stage parameterized metric program comprises a donor tray time under storage metric.
   206. An automated, computer implemented efficient plant order fulfillment system as described in clause 179, or any other clause, wherein said multi growth stage parameterized metric program comprises a donor tray cold storage time metric.
   207. An automated, computer implemented efficient plant order fulfillment system as described in clause 179, or any other clause, wherein said future week replacement tray has a replacement tray cell density, said customer tray has a customer tray cell density, and, or any other clause, wherein said replacement tray has a higher cell density than said customer tray cell density.
   208. An automated, computer implemented efficient plant order fulfillment system as described in clause 207, or any other clause, wherein said future week replacement tray cell density and said customer tray cell density comprise a cell density ratio of at least two to one.
   209. An automated, computer implemented efficient plant order fulfillment system as described in clause 207, or any other clause, wherein said future week replacement tray cell density and said customer tray cell density comprise a cell density ratio of at least three to one.
   210. An automated, computer implemented efficient plant order fulfillment system as described in clause 179 and, or any other clause, further comprising an input module to which said programmable plant growth configured computer system is responsive.
   211. An automated, computer implemented efficient plant order fulfillment system as described in clause 210, or any other clause, wherein said input module comprises an external operator input.
   212. An automated, computer implemented efficient plant order fulfillment system as described in clause 210, or any other clause, wherein said input module comprises an automated computer input.
   213. An automated, computer implemented efficient plant order fulfillment system as described in clause 179, or any other clause, wherein said customer tray automated propagule punch system comprises an automatically directed propagule punch system.
   214. An automated, computer implemented efficient plant order fulfillment system as described in clause 179, or any other clause, wherein said customer tray automated propagule punch system comprises an operator activated propagule punch system.
   215. An automated, computer implemented efficient plant order fulfillment system as described in clause 179, or any other clause, wherein said customer tray automated propagule punch system comprises a computer directed propagule punch system.
   216. An automated, computer implemented efficient plant order fulfillment system as described in clause 179, or any other clause, wherein said multi growth stage parameterized metric program comprises a future projection of transplant propagule need metric.
   217. An automated, computer implemented efficient plant order fulfillment system as described in clause 216, or any other clause, wherein said future projection of transplant propagule need metric comprises 100 percent customer order fulfillment metric.
   218. A method of cultivating plants for efficient order fulfillment comprising the steps of:
determining at least one multi-cycle replacement tray maximization metric;
utilizing said at least one multi-cycle replacement tray maximization metric to calculate a multi-cycle replacement tray cell parameter;
a first cycle transplanting at least a first multi-cycle replacement tray propagule to replace a defective first cycle customer tray propagule;
a second cycle transplanting at least a second multi-cycle replacement tray propagule to replace a defective second cycle customer tray propagule;
optimally fulfilling orders utilizing said customer tray having said at least first multi-cycle replacement tray propagule and said at least second multi-cycle replacement tray propagule.
   219. A method of cultivating plants for efficient order fulfillment as described in clause 218, or any other clause, wherein said at least one multi-cycle replacement tray maximization metric comprises an at least one multi-cycle replacement tray maximization metric of a meaningful growth period.
   220. A method of cultivating plants for efficient order fulfillment as described in clause 218, or any other clause, wherein at least one multi-cycle replacement tray maximization metric of a meaningful growth period comprises a growth period greater than or equal to 24 hours.
   221. A method of cultivating plants for efficient order fulfillment as described in clause 218, or any other clause, wherein said at least one multi growth stage parameterized metric comprises propagule a grow environment humidity metric.
   222. A method of cultivating plants for efficient order fulfillment as described in clause 219, or any other clause, wherein said at least one multi-cycle replacement tray maximization metric of a meaningful growth period comprises a storage environment humidity metric.
   223. A method of cultivating plants for efficient order fulfillment as described in clause 219, or any other clause, wherein said at least one multi-cycle replacement tray maximization metric of a meaningful growth period comprises a soil type metric.
   224. A method of cultivating plants for efficient order fulfillment as described in clause 219, or any other clause, wherein said at least one multi-cycle replacement tray maximization metric of a meaningful growth period comprises a feedwater flow rate metric.
   225. A method of cultivating plants for efficient order fulfillment as described in clause 219, or any other clause, wherein said at least one multi-cycle replacement tray maximization metric of a meaningful growth period comprises a weekly demand metric.
   226. A method of cultivating plants for efficient order fulfillment as described in clause 219, or any other clause, wherein said at least one multi-cycle replacement tray maximization metric of a meaningful growth period comprises a germination rate of customer tray metric.
   227. A method of cultivating plants for efficient order fulfillment as described in clause 219, or any other clause, wherein said at least one multi-cycle replacement tray maximization metric of a meaningful growth period comprises a germination rate of donor tray metric.
   228. A method of cultivating plants for efficient order fulfillment as described in clause 219, or any other clause, wherein said at least one multi-cycle replacement tray maximization metric of a meaningful growth period comprises a number of plants in inventory metric.
   229. A method of cultivating plants for efficient order fulfillment as described in clause 219, or any other clause, wherein said at least one multi-cycle replacement tray maximization metric of a meaningful growth period comprises a seed quality factor as variance in germination metric.
   230. A method of cultivating plants for efficient order fulfillment as described in 219, or any other clause, wherein said at least one multi-cycle replacement tray maximization metric of a meaningful growth period comprises a donor plants required metric.
   231. A method of cultivating plants for efficient order fulfillment as described in clause 219, or any other clause, wherein said at least one multi-cycle replacement tray maximization metric of a meaningful growth period comprises a risk factor metric.
   232. A method of cultivating plants for efficient order fulfillment as described in clause 219, or any other clause, wherein said at least one multi-cycle replacement tray maximization metric of a meaningful growth period comprises a future weeks required for donor plants metric.
   233. A method of cultivating plants for efficient order fulfillment as described in clause 219, or any other clause, wherein said at least one multi-cycle replacement tray maximization metric of a meaningful growth period comprises a total demand for donor metric.
   234. A method of cultivating plants for efficient order fulfillment as described in 219, or any other clause, wherein said at least one multi-cycle replacement tray maximization metric of a meaningful growth period comprises a consumer time under light metric.
   235. A method of cultivating plants for efficient order fulfillment as described in clause 219, or any other clause, wherein said at least one multi-cycle replacement tray maximization metric of a meaningful growth period comprises a donor time under light metric.
   236. A method of cultivating plants for efficient order fulfillment as described in 219, or any other clause, wherein said at least one multi-cycle replacement tray maximization metric of a meaningful growth period comprises a donor time under storage metric.
   237. A method of cultivating plants for efficient order fulfillment as described in clause 219, or any other clause, wherein said at least one multi-cycle replacement tray maximization metric of a meaningful growth period comprises a donor cold storage time metric.
   238. A method of cultivating plants for efficient order fulfillment as described in clause 218, or any other clause, wherein at least one multi-cycle replacement tray maximization metric of a meaningful growth period comprises a root ball volume ratio.
   239. A method of cultivating plants for efficient order fulfillment as described in clause 218, or any other clause, wherein said at least one multi-cycle replacement tray maximization metric of a meaningful growth period comprises a replacement tray root ball volume
   240. A method of cultivating plants for efficient order fulfillment as described in clause 218, or any other clause, wherein said multi-cycle replacement tray propagule comprises a replacement tray with a higher propagule cell density than a cell density of a customer tray.
   241. A method of cultivating plants for efficient order fulfillment as described in clause 240, or any other clause, wherein said multi-cycle replacement tray with a higher propagule cell density than a cell density of a customer tray comprises a cell density ratio of at least two to one.
   242. A method of cultivating plants for efficient order fulfillment as described in clause 240, or any other clause, wherein said multi-cycle replacement tray with a higher propagule cell density than a cell density of a customer tray comprises a cell density ratio of at least three to one.
   243. A method of cultivating plants for efficient order fulfillment as described in clause 218 and, or any other clause, further comprising the step of interfacing with an input module.
   244. A method of cultivating plants for efficient order fulfillment as described in clause 243, or any other clause, wherein said input module comprises an operator.
   245. A method of cultivating plants for efficient order fulfillment as described in clause 243, or any other clause, wherein said input module a central processing unit.
   246. A method of cultivating plants for efficient order fulfillment as described in clause 218, or any other clause, wherein said replacement tray propagule comprises an automatic replacement of a replacement tray propagule through the use of an automated plant punching system.
   247. A method of cultivating plants for efficient order fulfillment as described in clause 246, or any other clause, further comprising the step of interfacing with an input module.
   248. A method of cultivating plants for efficient order fulfillment as described in clause 247, or any other clause, wherein said input module comprises an external operator input.
   249. A method of cultivating plants for efficient order fulfillment as described in clause 246, or any other clause, wherein said plant punching system comprises an artificially intelligent plant punching system.
   250. A method of cultivating plants for efficient order fulfillment as described in clause 218, or any other clause, wherein said yield maximization metric comprises future projection of transplant propagule need.
   251. A method of cultivating plants for efficient order fulfillment as described in clause 250, or any other clause, wherein said future projection of transplant propagule need comprises 100 percent customer order fulfillment.
   252. A method of cultivating plants for efficient order fulfillment comprising the steps of:
determining at least one multi-cycle replacement tray maximization metric;
determining the multi-cycle future propagule order fulfillment requirement;
primarily growing a first cycle customer tray having a plurality of propagules;
at least part simultaneously differentially growing a multi-cycle replacement tray based on said multi-cycle future propagule order fulfillment requirement and said at least one multi-cycle replacement tray maximization metric;
transplanting a multi-cycle replacement tray propagule from said multi-cycle replacement tray to replace a defective first cycle customer tray propagule in said first cycle customer tray;
primarily growing a second cycle customer tray having a plurality of second cycle customer tray propagules; and
transplanting a multi-cycle replacement tray propagule from said multi-cycle replacement tray to replace a defective second cycle customer tray propagule.
   253. A method of cultivating plants for efficient order fulfillment as described in 252, or any other clause, wherein said multi-cycle replacement tray comprises a higher cell density multi-cycle replacement tray than said first cycle customer tray, having a first cycle customer tray cell density
   254. A method of cultivating plants for efficient order fulfillment as described in 252, or any other clause, wherein said multi-cycle replacement tray comprises a multi-cycle replacement tray cell density at least three times that of said first cycle customer tray, having a first cycle customer tray cell density.
   255. A method of cultivating plants for efficient order fulfillment as described in 252, or any other clause, wherein said multi-cycle replacement tray comprises a higher cell density multi-cycle replacement tray than said second cycle customer tray, having a second cycle customer tray cell density.
   256. A method of cultivating plants for efficient order fulfillment as described in 252, or any other clause, wherein said multi-cycle replacement tray comprises a multi-cycle replacement tray cell density at least three times that of said second cycle customer tray, having a second cycle customer tray cell density.
   257. A method of cultivating plants for efficient order fulfillment as described in clause 252, or any other clause, wherein said at least one multi growth stage parameterized metric comprises a propagule grow environment humidity metric.
   258. A method of cultivating plants for efficient order fulfillment as described in clause 252, or any other clause, wherein said multi-cycle replacement tray maximization metric comprises a storage environment humidity metric.
   259. A method of cultivating plants for efficient order fulfillment as described in clause 252, or any other clause, wherein said multi-cycle replacement tray maximization metric comprises a soil type metric.
   260. A method of cultivating plants for efficient order fulfillment as described in clause 252, or any other clause, wherein said multi-cycle replacement tray maximization metric comprises a feedwater flow rate metric.
   261. A method of cultivating plants for efficient order fulfillment as described in clause 252, or any other clause, wherein said multi-cycle replacement tray maximization metric comprises a weekly demand metric.
   262. A method of cultivating plants for efficient order fulfillment as described in clause 252, or any other clause, wherein said multi-cycle replacement tray maximization metric comprises a germination rate of customer tray metric.
   263. A method of cultivating plants for efficient order fulfillment as described in clause 252, or any other clause, wherein said multi-cycle replacement tray maximization metric comprises a germination rate of donor tray metric.
   264. A method of cultivating plants for efficient order fulfillment as described in clause 252, or any other clause, wherein multi-cycle replacement tray maximization metric comprises a number of plants in inventory metric.
   265. A method of cultivating plants for efficient order fulfillment as described in clause 252, or any other clause, wherein said multi-cycle replacement tray maximization metric comprises a seed quality factor as variance in germination metric.
   266. A method of cultivating plants for efficient order fulfillment as described in 252, or any other clause, wherein said multi-cycle replacement tray maximization metric comprises a donor plants required metric.
   267. A method of cultivating plants for efficient order fulfillment as described in clause 252, or any other clause, wherein said multi-cycle replacement tray maximization metric comprises a risk factor metric.
   268. A method of cultivating plants for efficient order fulfillment as described in clause 252, or any other clause, wherein said multi-cycle replacement tray maximization metric comprises a future weeks required for donor plants metric.
   269. A method of cultivating plants for efficient order fulfillment as described in clause 252, or any other clause, wherein said multi-cycle replacement tray maximization metric comprises a total demand for donor propagule metric.
   270. A method of cultivating plants for efficient order fulfillment as described in 252, or any other clause, wherein multi-cycle replacement tray maximization metric comprises a consumer tray time under light metric.
   271. A method of cultivating plants for efficient order fulfillment as described in clause 252, or any other clause, wherein said multi-cycle replacement tray maximization metric comprises a donor tray time under light metric.
   272. A method of cultivating plants for efficient order fulfillment as described in 252, or any other clause, wherein said multi-cycle replacement tray maximization metric comprises a donor tray time under storage metric.
   273. A method of cultivating plants for efficient order fulfillment as described in clause 252, or any other clause, wherein said multi-cycle replacement tray maximization metric comprises a donor tray cold storage time metric.
   274. A method of cultivating plants for efficient order fulfillment as described in clause 252, or any other clause, wherein said multi-cycle replacement tray maximization metric comprises a root ball volume ratio.
   275. A method of cultivating plants for efficient order fulfillment as described in clause 252, or any other clause, wherein said multi-cycle replacement tray maximization metric comprises a replacement tray root ball volume being at least two times smaller than a customer tray root ball volume.
   276. A method of cultivating plants for efficient order fulfillment as described in clause 252, or any other clause, wherein said replacement tray propagule comprises a replacement tray with a higher propagule cell density than a cell density of a customer tray, having a customer tray cell density.
   277. A method of cultivating plants for efficient order fulfillment as described in clause 276, or any other clause, wherein said replacement tray with a higher propagule cell density than a cell density of a customer tray comprises a cell density ratio of at least two to one.
   278. A method of cultivating plants for efficient order fulfillment as described in clause 276, or any other clause, wherein said replacement tray with a higher propagule cell density than a cell density of a customer tray comprises a cell density ratio of at least three to one.
   279. A method of cultivating plants for efficient order fulfillment as described in clause 252 and, or any other clause, further comprising the step of interfacing with an input module.
   280. A method of cultivating plants for efficient order fulfillment as described in clause 279, or any other clause, wherein said input module comprises an operator input.
   281. A method of cultivating plants for efficient order fulfillment as described in clause 279, or any other clause, wherein said input module a central processing unit.
   282. A method of cultivating plants for efficient order fulfillment as described in clause 252, or any other clause, wherein said replacement tray propagule comprises an automatic replacement of a replacement tray propagule through the use of an automated plant punching system 283. A method of cultivating plants for efficient order fulfillment as described in clause 252, or any other clause, wherein said automatic replacement of a replacement tray propagule comprises replacing a propagule by an external operator plant punching system.
   284. A method of cultivating plants for efficient order fulfillment as described in clause 282, or any other clause, wherein said plant punching system comprises an artificially intelligent computer plant punching system.
   285. A method of cultivating plants for efficient order fulfillment as described in clause 252, or any other clause, wherein said yield maximization metric comprises future projection of transplant propagule need metric.
   286. A method of cultivating plants for efficient order fulfillment as described in clause 285, or any other clause, wherein said future projection of transplant propagule need metric comprises 100 percent customer order fulfillment metric.
   287. An automated, computer implemented efficient plant order fulfillment system comprising:
a programmable plant growth configured computer system;
at least one computer stored, multi-cycle replacement tray maximization metric program stored in said programmable plant growth configured computer system, or any other clause, wherein said at least one computer stored, multi-cycle replacement tray maximization metric program includes parameters based on prior propagule growth information, and includes quantitative plant multi-growth stage parameterized horticultural growth relationships;
a multi-cycle future propagule order fulfillment requirement input for said programmable plant growth configured computer system, and that interfaces with said at least one computer stored, multi-cycle replacement tray maximization metric program;
a first cycle customer tray having a plurality of propagules;
a first cycle customer tray primary growth environment control having an operator interface with said programmable plant growth configured computer system;
a first cycle customer primary growth environment configured to influence said first cycle customer tray, and to operate as automatically provided for a program implemented to utilize said at least one multi-cycle replacement tray maximization metric in said programmable plant growth configured computer system;
a multi-cycle replacement tray having a plurality of donor propagules;
an at least partly simultaneous, differential donor growth environment control having an operator interface with said programmable plant growth configured computer system;
a donor growth environment configured to operate as automatically provided for a program implemented to utilize said at least one multi-cycle replacement tray maximization metric in said programmable plant growth configured computer system;
a first cycle customer tray automated propagule punch system;
a second cycle customer tray having a plurality of propagules;
a second cycle customer tray primary growth environment control having an operator interface with said programmable plant growth configured computer system;
a second cycle customer primary growth environment configured to influence said second cycle customer tray, and to operate as automatically provided for a program implemented to utilize said at least one multi-cycle replacement tray maximization metric in said programmable plant growth configured computer system; and
a second cycle customer tray automated propagule punch system.
   288. An automated, computer implemented efficient plant order fulfillment system as described in clause 287, or any other clause, further comprising:
a first replacement need acceptance subroutine stored in said programmable plant growth configured computer system;
a first transplant indicator stored in said programmable plant growth configured computer system;
a second replacement need acceptance subroutine stored in said programmable plant growth configured computer system; and
a second transplant indicator stored in said programmable plant growth configured computer system.
   289. An automated, computer implemented efficient plant order fulfillment system as described in clause 287, or any other clause, wherein said first cycle customer tray has a first cycle customer tray cell density, and, or any other clause, wherein said multi-cycle replacement tray has a higher cell density than said first cycle customer tray cell density.
   290. An automated, computer implemented efficient plant order fulfillment system as described in clause 287, or any other clause, wherein said first cycle customer tray has a first cycle customer tray cell density, and, or any other clause, wherein said multi-cycle replacement tray has a cell density that is at least three times that of said first cycle customer tray cell density.
   291. An automated, computer implemented efficient plant order fulfillment system as described in clause 287, or any other clause, wherein said second cycle customer tray has a second cycle customer tray cell density, and, or any other clause, wherein said multi-cycle replacement tray has a higher cell density than said second cycle customer tray cell density.
   292. An automated, computer implemented efficient plant order fulfillment system as described in clause 287, or any other clause, wherein said second cycle customer tray has a second cycle customer tray cell density, and, or any other clause, wherein said multi-cycle replacement tray has a cell density that is at least three times that of said second cycle customer tray cell density.
   293. An automated, computer implemented efficient plant order fulfillment system as described in clause 287, or any other clause, wherein said at least one computer stored, multi-cycle replacement tray maximization metric program comprises a propagule grow environment humidity metric.
   294. An automated, computer implemented efficient plant order fulfillment system as described in clause 287, or any other clause, wherein said at least one computer stored, multi-cycle replacement tray maximization metric program comprises a storage environment humidity metric.
   295. An automated, computer implemented efficient plant order fulfillment system as described in clause 287, or any other clause, wherein said at least one computer stored, multi-cycle replacement tray maximization metric program comprises a soil type metric.
   296. An automated, computer implemented efficient plant order fulfillment system as described in clause 287, or any other clause, wherein said at least one computer stored, multi-cycle replacement tray maximization metric program comprises a feedwater flow rate metric.
   297. An automated, computer implemented efficient plant order fulfillment system as described in clause 287, or any other clause, wherein said at least one computer stored, multi-cycle replacement tray maximization metric program comprises a weekly demand metric.
   298. An automated, computer implemented efficient plant order fulfillment system as described in clause 287, or any other clause, wherein said at least one computer stored, multi-cycle replacement tray maximization metric program comprises a germination rate of customer tray metric.
   299. An automated, computer implemented efficient plant order fulfillment system as described in clause 287, or any other clause, wherein said at least one computer stored, multi-cycle replacement tray maximization metric program comprises a germination rate of donor tray metric.
   300. An automated, computer implemented efficient plant order fulfillment system as described in clause 287, or any other clause, wherein said at least one computer stored, multi-cycle replacement tray maximization metric program comprises a number of plants in inventory metric.
   301. An automated, computer implemented efficient plant order fulfillment system as described in clause 287, or any other clause, wherein said at least one computer stored, multi-cycle replacement tray maximization metric program comprises a seed quality factor as variance in germination metric.
   302. An automated, computer implemented efficient plant order fulfillment system as described in clause 287, or any other clause, wherein said at least one computer stored, multi-cycle replacement tray maximization metric program comprises a donor plants required metric.
   303. An automated, computer implemented efficient plant order fulfillment system as described in clause 287, or any other clause, wherein said at least one computer stored, multi-cycle replacement tray maximization metric program comprises a risk factor metric.
   304. An automated, computer implemented efficient plant order fulfillment system as described in clause 287, or any other clause, wherein said at least one computer stored, multi-cycle replacement tray maximization metric program comprises a future weeks required for donor plants metric.
   305. An automated, computer implemented efficient plant order fulfillment system as described in clause 287, or any other clause, wherein said at least one computer stored, multi-cycle replacement tray maximization metric program comprises a total demand for donor propagules metric.
   306. An automated, computer implemented efficient plant order fulfillment system as described in clause 287, or any other clause, wherein said at least one computer stored, multi-cycle replacement tray maximization metric program comprises a consumer tray time under light metric.
   307. An automated, computer implemented efficient plant order fulfillment system as described in clause 287, or any other clause, wherein said at least one computer stored, multi-cycle replacement tray maximization metric program comprises a donor tray time under light metric.
   308. An automated, computer implemented efficient plant order fulfillment system as described in clause 287, or any other clause, wherein said at least one computer stored, multi-cycle replacement tray maximization metric program comprises a donor tray time under storage metric.
   309. An automated, computer implemented efficient plant order fulfillment system as described in clause 287, or any other clause, wherein said at least one computer stored, multi-cycle replacement tray maximization metric program comprises a donor tray cold storage time metric.
   310. An automated, computer implemented efficient plant order fulfillment system as described in clause 287, or any other clause, wherein said at least one computer stored, multi-cycle replacement tray maximization metric program comprises a root ball volume ratio metric.
   311. An automated, computer implemented efficient plant order fulfillment system as described in clause 287, or any other clause, wherein said at least one computer stored, multi-cycle replacement tray maximization metric program comprises a replacement tray root ball volume being at least two times smaller than a customer tray root ball volume metric.
   312. An automated, computer implemented efficient plant order fulfillment system as described in clause 287, or any other clause, wherein said multi-cycle replacement tray has a multi-cycle replacement tray cell density, first cycle customer tray has a first cycle customer tray cell density, and, or any other clause, wherein said multi-cycle replacement tray has a higher cell density than said first cycle customer tray cell density.
   313. An automated, computer implemented efficient plant order fulfillment system as described in clause 287, or any other clause, wherein said multi-cycle replacement tray cell density and said first cycle customer tray cell density comprise a cell density ratio of at least two to one.
   314. An automated, computer implemented efficient plant order fulfillment system as described in clause 287, or any other clause, wherein said multi-cycle replacement tray cell density and said first cycle customer tray cell density comprise a cell density ratio of at least three to one.
   315. An automated, computer implemented efficient plant order fulfillment system as described in clause 287 and, or any other clause, further comprising an input module to which said automated, computer implemented efficient plant order fulfillment system is responsive.
   316. An automated, computer implemented efficient plant order fulfillment system as described in clause 315, or any other clause, wherein said input module comprises an external operator input.
   317. An automated, computer implemented efficient plant order fulfillment system as described in clause 315, or any other clause, wherein said input module comprises an automated computer input.
   318. An automated, computer implemented efficient plant order fulfillment system as described in clause 287, or any other clause, wherein said first cycle customer tray automated propagule punch system and said second cycle customer tray automated propagule punch system each comprise an automatically directed propagule punch system.
   319. An automated, computer implemented efficient plant order fulfillment system as described in clause 287, or any other clause, wherein said first cycle customer tray automated propagule punch system and said second cycle customer tray automated propagule punch system each comprise an operator activated propagule punch system.
   320. An automated, computer implemented efficient plant order fulfillment system as described in clause 287, or any other clause, wherein said first cycle customer tray automated propagule punch system and second cycle customer tray automated propagule punch system each comprise a computer directed propagule punch system.
   321. An automated, computer implemented efficient plant order fulfillment system as described in clause 287, or any other clause, wherein said at least one computer stored, multi-cycle replacement tray maximization metric program comprises a future projection of transplant propagule need metric.
   322. An automated, computer implemented efficient plant order fulfillment system as described in clause 287, or any other clause, wherein said future projection of transplant propagule need metric comprises 100 percent customer order fulfillment metric.
   323. A method of cultivating plants for efficient order fulfillment comprising the steps of:
determining at least one multi growth stage parameterized metric;
utilizing said at least one multi growth stage parameterized metric to configure metrically controlled processes to replace a customer tray propagule;
calculating a reduced replacement parameter based on future customer tray propagule need;
interfacing said at least one multi growth stage parameterized metric with an input module;
inputting said at least one multi growth stage parameterized metric to said input module;
utilizing said reduced replacement parameter to maximize customer tray propagule cultivation; and
achieving maximize order fulfillment production yield which is statistically increased over a traditional transplant production period.
   324. A method of cultivating plants for efficient order fulfillment as described in clause 323, or any other clause, wherein said at least one multi growth stage parameterized metric comprises propagule a grow environment humidity metric.
   325. A method of cultivating plants for efficient order fulfillment as described in clause 323, or any other clause, wherein said multi-cycle replacement tray maximization metric comprises a storage environment humidity metric.
   326. A method of cultivating plants for efficient order fulfillment as described in clause 323, or any other clause, wherein said multi-cycle replacement tray maximization metric comprises a soil type metric.
   327. A method of cultivating plants for efficient order fulfillment as described in clause 323, or any other clause, wherein said multi-cycle replacement tray maximization metric comprises a feedwater flow rate metric.
   328. A method of cultivating plants for efficient order fulfillment as described in clause 323, or any other clause, wherein said multi-cycle replacement tray maximization metric comprises a weekly demand metric.
   329. A method of cultivating plants for efficient order fulfillment as described in clause 323, or any other clause, wherein said multi-cycle replacement tray maximization metric comprises a germination rate of customer tray metric.
   330. A method of cultivating plants for efficient order fulfillment as described in clause 323, or any other clause, wherein said multi-cycle replacement tray maximization metric comprises a germination rate of donor tray metric.
   331. A method of cultivating plants for efficient order fulfillment as described in clause 323, or any other clause, wherein multi-cycle replacement tray maximization metric comprises a number of plants in inventory metric.
   332. A method of cultivating plants for efficient order fulfillment as described in clause 323, or any other clause, wherein said multi-cycle replacement tray maximization metric comprises a seed quality factor as variance in germination metric.
   333. A method of cultivating plants for efficient order fulfillment as described in 323, or any other clause, wherein said multi-cycle replacement tray maximization metric comprises a donor plants required metric.
   334. A method of cultivating plants for efficient order fulfillment as described in clause 323, or any other clause, wherein said multi-cycle replacement tray maximization metric comprises a risk factor metric.
   335. A method of cultivating plants for efficient order fulfillment as described in clause 323, or any other clause, wherein said multi-cycle replacement tray maximization metric comprises a future weeks required for donor plants metric.
   336. A method of cultivating plants for efficient order fulfillment as described in clause 323, or any other clause, wherein said multi-cycle replacement tray maximization metric comprises a total demand for donor propagule metric.
   337. A method of cultivating plants for efficient order fulfillment as described in 323, or any other clause, wherein multi-cycle replacement tray maximization metric comprises a consumer tray time under light metric.
   338. A method of cultivating plants for efficient order fulfillment as described in clause 323, or any other clause, wherein said multi-cycle replacement tray maximization metric comprises a donor tray time under light metric.
   339. A method of cultivating plants for efficient order fulfillment as described in 323, or any other clause, wherein said multi-cycle replacement tray maximization metric comprises a donor tray time under storage metric.
   340. A method of cultivating plants for efficient order fulfillment as described in clause 323, or any other clause, wherein said multi-cycle replacement tray maximization metric comprises a donor tray cold storage time metric.
   341. A method of cultivating plants for efficient order fulfillment as described in clause 323, or any other clause, wherein said replacement tray propagule comprises a replacement tray with a higher propagule cell density than a cell density of a customer tray.
   342. A method of cultivating plants for efficient order fulfillment as described in clause 323, or any other clause, wherein said multi-cycle replacement tray maximization metric comprises a root ball volume ratio.
   343. A method of cultivating plants for efficient order fulfillment as described in clause 323, or any other clause, wherein said multi-cycle replacement tray maximization metric comprises a replacement tray root ball volume being at least two times smaller than a customer tray root ball volume.
   344. A method of cultivating plants for efficient order fulfillment as described in clause 341, or any other clause, wherein said replacement tray with a higher propagule cell density than a cell density of a customer tray comprises a cell density ratio of at least two to one.
   345. A method of cultivating plants for efficient order fulfillment as described in clause 341, or any other clause, wherein said replacement tray with a higher propagule cell density than a cell density of a customer tray comprises a cell density ratio of at least three to one.
   346. A method of cultivating plants for efficient order fulfillment as described in clause 323 and, or any other clause, further comprising the step of interfacing with an input module.
   347. A method of cultivating plants for efficient order fulfillment as described in clause 346, or any other clause, wherein said input module comprises an operator.
   348. A method of cultivating plants for efficient order fulfillment as described in clause 346, or any other clause, wherein said input module a central processing unit.
   349. A method of cultivating plants for efficient order fulfillment as described in clause 323, or any other clause, wherein said replacement tray propagule comprises an automatic replacement tray propagule and a plant punching system.
   350. A method of cultivating plants for efficient order fulfillment as described in clause 323, or any other clause, wherein said replacement tray propagule comprises a replacement tray propagule operator.
   351. A method of cultivating plants for efficient order fulfillment as described in clause 350, or any other clause, wherein said plant punching system comprises an artificially intelligent plant punching system.
   352. A method of cultivating plants for efficient order fulfillment as described in clause 323, or any other clause, wherein said yield maximization metric comprises future projection of transplant propagule need.
   353. A method of cultivating plants for efficient order fulfillment as described in clause 352, or any other clause, wherein said future projection of transplant propagule need comprises 100 percent customer order fulfillment.
   354. A method of cultivating plants to optimize growth economics comprising the steps of:
determining at least one multi growth stage parameterized metric for transplanting propagules;
utilizing said at least multi growth stage parameterized metric an optimal time and a future propagule requirement;
calculating said optimal time and said future propagule requirement to optimize transplant efficiencies; and
reducing transplant propagule waste through optimized transplant efficiencies.
   355. A method of cultivating plants to optimize growth economics as described in clause 354, or any other clause, wherein said optimal time comprises optimal transplant propagule storage time.
   356. A method of cultivating plants to optimize growth economics as described in clause 354, or any other clause, wherein said optimal time comprises optimal transplant propagule growth time.
   357. A method of cultivating plants to optimize growth economics as described in clause 354, or any other clause, wherein said at least one multi growth stage parameterized metric comprises propagule a grow environment humidity metric.
   358. A method of cultivating plants to optimize growth economics as described in clause 354, or any other clause, wherein said multi-cycle replacement tray maximization metric comprises a storage environment humidity metric.
   359. A method of cultivating plants to optimize growth economics as described in clause 354, or any other clause, wherein said multi-cycle replacement tray maximization metric comprises a soil type metric.
   360. A method of cultivating plants to optimize growth economics as described in clause 354, or any other clause, wherein said multi-cycle replacement tray maximization metric comprises a feedwater flow rate metric.
   361. A method of cultivating plants to optimize growth economics as described in clause 354, or any other clause, wherein said multi-cycle replacement tray maximization metric comprises a weekly demand metric.
   362. A method of cultivating plants to optimize growth economics as described in clause 354, or any other clause, wherein said multi-cycle replacement tray maximization metric comprises a germination rate of customer tray metric.
   363. A method of cultivating plants to optimize growth economics as described in clause 354, or any other clause, wherein said multi-cycle replacement tray maximization metric comprises a germination rate of donor tray metric.
   364. A method of cultivating plants to optimize growth economics as described in clause 354, or any other clause, wherein multi-cycle replacement tray maximization metric comprises a number of plants in inventory metric.
   365. A method of cultivating plants to optimize growth economics as described in clause 354, or any other clause, wherein said multi-cycle replacement tray maximization metric comprises a seed quality factor as variance in germination metric.
   366. A method of cultivating plants to optimize growth economics as described in clause 354, or any other clause, wherein said multi-cycle replacement tray maximization metric comprises a donor plants required metric.
   367. A method of cultivating plants to optimize growth economics as described in clause 354, or any other clause, wherein said multi-cycle replacement tray maximization metric comprises a risk factor metric.
   368. A method of cultivating plants to optimize growth economics as described in clause 354, or any other clause, wherein said multi-cycle replacement tray maximization metric comprises a future weeks required for donor plants metric.
   369. A method of cultivating plants to optimize growth economics as described in clause 354, or any other clause, wherein said multi-cycle replacement tray maximization metric comprises a total demand for donor metric.
   370. A method of cultivating plants to optimize growth economics as described in clause 354, or any other clause, wherein multi-cycle replacement tray maximization metric comprises a consumer tray time under light metric.
   371. A method of cultivating plants to optimize growth economics as described in clause 354, or any other clause, wherein said multi-cycle replacement tray maximization metric comprises a donor tray time under light metric.
   372. A method of cultivating plants to optimize growth economics as described in clause 354, or any other clause, wherein said multi-cycle replacement tray maximization metric comprises a donor time under storage metric.
   373. A method of cultivating plants to optimize growth economics as described in clause 354, or any other clause, wherein said multi-cycle replacement tray maximization metric comprises a donor tray cold storage time metric.
   374. A method of cultivating plants for efficient order fulfillment as described in clause 354, or any other clause, wherein said multi-cycle replacement tray maximization metric comprises a root ball volume ratio.
   375. A method of cultivating plants for efficient order fulfillment as described in clause 354, or any other clause, wherein said multi-cycle replacement tray maximization metric comprises a replacement tray root ball volume being at least two times smaller than a customer tray root ball volume.
   376. A method of cultivating plants to optimize growth economics as described in clause 354, or any other clause, wherein said replacement tray propagule comprises a replacement tray with a higher propagule cell density than a cell density of a customer tray.
   377. A method of cultivating plants to optimize growth economics as described in clause 376, or any other clause, wherein said replacement tray with a higher propagule cell density than a cell density of a customer tray comprises a cell density ratio of at least two to one.
   378. A method of cultivating plants to optimize growth economics as described in clause 376, or any other clause, wherein said replacement tray with a higher propagule cell density than a cell density of a customer tray comprises a cell density ratio of at least three to one.
   379. A method of cultivating plants to optimize growth economics as described in clause 354, or any other clause, wherein and, or any other clause, further comprising the step of interfacing with an input module.
   380. A method of cultivating plants to optimize growth economics as described in clause 379, or any other clause, wherein said input module comprises an operator.
   381. A method of cultivating plants for efficient order fulfillment as described in clause 379, or any other clause, wherein said input module a central processing unit.
   382. A method of cultivating plants for efficient order fulfillment as described in clause 354, or any other clause, wherein said replacement tray propagule comprises an automatic replacement of a replacement tray propagule through the use of an automated plant punching system.
   383. A method of cultivating plants for efficient order fulfillment as described in clause 354, or any other clause, wherein said automatic replacement of a replacement tray propagule comprises replacing a propagule by an external operator plant punching system.
   384. A method of cultivating plants for efficient order fulfillment as described in clause 382, or any other clause, wherein said plant punching system comprises an artificially intelligent plant punching system.
   385. A method of cultivating plants for efficient order fulfillment as described in clause 354, or any other clause, wherein said yield maximization metric comprises future projection of transplant propagule need.
   386. A method of cultivating plants for efficient order fulfillment as described in clause 385, or any other clause, wherein said future projection of transplant propagule need comprises 100 percent customer order fulfillment.

As can be easily understood from the foregoing, the basic concepts of the present invention may be embodied in a variety of ways. It involves both plant donor techniques as well as devices to accomplish the appropriate plant donation. In this application, the plant donor techniques are disclosed as part of the results shown to be achieved by the various devices described and as steps that are inherent to utilization. They are simply the natural result of utilizing the devices as intended and described. In addition, while some devices are disclosed, it should be understood that these not only accomplish certain methods but also can be varied in a number of ways. Importantly, as to all of the foregoing, all of these facets should be understood to be encompassed by this disclosure.

The discussion included in this nonprovisional application is intended to serve as a basic description. The reader should be aware that the specific discussion may not explicitly describe all embodiments possible; many alternatives are implicit. It also may not fully explain the generic nature of the invention and may not explicitly show how each feature or element can actually be representative of a broader function of a great variety of alternative or equivalent elements. As one example, terms of degree, terms of approximation, and/or relative terms may be used. These may include terms such as the words: substantially, about, only, and the like. These words and types of words are to be understood in a dictionary sense as terms that encompass an ample or considerable amount, quantity, size, etc. as well as terms that encompass largely but not wholly that which is specified. Further, for this application, if or when used, terms of degree, terms of approximation, and/or relative terms should be understood as also encompassing more precise and even quantitative values that include various levels of precision and the possibility of claims that address a number of quantitative options and alternatives. For example, to the extent ultimately used, the existence or non-existence of an amount, result, or outcome in a particular variable, input, output, or at a particular stage can be specified as substantially the same as x or substantially avoiding of x, as a value of about x, or such other similar language. Using percentage values as one example, these types of terms should be understood as encompassing the options of percentage values that include 99%, 97%, 95%, 92%, and even 90% of the specified value or relative condition; correspondingly for values at the other end of the spectrum substantially free of or avoiding x, these should be understood as encompassing the options of percentage values that include not more than 1%, 3%, 5%, 8% or even 10% of the specified value or relative condition. For example, using percentage values as one example, for the transplanted product to be substantially the only desired product, it should be understood that embodiments of the invention may encompass the option of ball area size percentage values that include 70%, 60%, 50%, 37.5%, or even 25% of the retailer saleable ball being the desired donor tray ball or the like. Correspondingly for values at the other end of the spectrum (e.g., embodiments of the invention should be understood as encompassing the options of multiple values that include the possibility of having donor tray cell numbers that are at least 4×, 2.67×, 2×, 1.67×, and 1.43× retailer saleable tray cell numbers). In context, these should be understood by a person of ordinary skill as being disclosed and included whether in an absolute value sense or in valuing one set of or substance as compared to the value of a second set of or substance. Again, these are implicitly included in this disclosure and should (and, it is believed, would) be understood to a person of ordinary skill in this field. Where the invention is described in device-oriented terminology, each element of the device implicitly performs a function. Apparatus claims may not only be included for the device described but also method or process claims may be included to address the functions the invention and each element performs. Neither the description nor the terminology is intended to limit the scope of the claims that will be included in any subsequent patent application.

It should also be understood that a variety of changes may be made without departing from the essence of the invention. Such changes are also implicitly included in the description. They still fall within the scope of this invention. A broad disclosure encompassing both the explicit embodiment(s) shown, the great variety of implicit alternative embodiments, and the broad methods or processes and the like are encompassed by this disclosure and may be relied upon when drafting the claims for any subsequent patent application. It should be understood that such language changes and broader or more detailed claiming may be accomplished at a later date (such as by any required deadline) or in the event the applicant subsequently seeks a patent filing based on this filing. With this understanding, the reader should be aware that this disclosure is to be understood to support any subsequently filed patent application that may seek examination of as broad a base of claims as deemed within the applicant's right and may be designed to yield a patent covering numerous aspects of the invention both independently and as an overall system.

### Examples of Alternative

Further, each of the various elements of the invention and claims may also be achieved in a variety of manners. Additionally, when used or implied, an element is to be understood as encompassing individual as well as plural structures that may or may not be physically connected. This disclosure should be understood to encompass each such variation, be it a variation of an embodiment of any apparatus embodiment, a method or process embodiment, or even merely a variation of any element of these. Particularly, it should be understood that as the disclosure relates to elements of the invention, the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled. As but one example, it should be understood that all actions may be expressed as a means for taking that action or as an element which causes that action. Similarly, each physical element disclosed should be understood to encompass a disclosure of the action which that physical element facilitates. Regarding this last aspect, as but one example, the disclosure of a “donor plant” should be understood to encompass disclosure of the act of “donating” or “act of providing a donor plant”—whether explicitly discussed or not—and, conversely, were there effectively disclosure of the act of “donating”, such a disclosure should be understood to encompass disclosure of a “donor plant” and even a “means for donating”. Such changes and alternative terms are to be understood to be explicitly included in the description. Further, each such means (whether explicitly so described or not) should be understood as encompassing all elements that can perform the given function, and all descriptions of elements that perform a described function should be understood as a non-limiting example of means for performing that function.

Any patents, publications, or other references mentioned in this application for patent are hereby incorporated by reference. Any priority case(s) claimed by this application is hereby appended and hereby incorporated by reference. In addition, as to each term used it should be understood that unless its utilization in this application is inconsistent with a broadly supporting interpretation, common dictionary definitions should be understood as incorporated for each term and all definitions, alternative terms, and synonyms such as contained in the Random House Webster's Unabridged Dictionary, second edition are hereby incorporated by reference. Finally, all references listed in the list of References To Be Incorporated By Reference In Accordance With The Patent Application or other information statement filed with the application are hereby appended and hereby incorporated by reference, however, as to each of the above, to the extent that such information or statements incorporated by reference might be considered inconsistent with the patenting of this/these invention(s) such statements are expressly not to be considered as made by the applicant(s).

Thus, the applicant(s) should be understood to have support to claim and make a statement of invention to at least: i) each of the transplanting devices as herein disclosed and described, ii) the related methods disclosed and described, iii) similar, equivalent, and even implicit variations of each of these devices and methods, iv) those alternative designs which accomplish each of the functions shown as are disclosed and described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such processes, methods, systems or components, ix) each system, method, and element shown or described as now applied to any specific field or devices mentioned, x) methods and apparatuses substantially as described hereinbefore and with reference to any of the accompanying examples, xi) an apparatus for performing the methods described herein comprising means for performing the steps, xii) the various combinations and permutations of each of the elements disclosed, xiii) each potentially dependent claim or concept as a dependency on each and every one of the independent claims or concepts presented, and xiv) all inventions described herein.

In addition and as to computer aspects and each aspect amenable to programming, logic, or other electronic automation, it should be understood that in characterizing these and all other aspects of the invention—whether characterized as a device, a capability, an element, or otherwise, because all of these can be implemented via software, hardware, or even firmware structures as set up for a general-purpose computer, a programmed chip or chipset, an ASIC, application-specific controller, subroutine, or other known programmable or circuit-specific structure—it should be understood that all such aspects are at least defined by structures including, a person of ordinary skill in the art would well recognize: hardware circuitry, firmware, programmed application-specific components, and even a general-purpose computer programmed to accomplish the identified aspect. For such items implemented by programmable features, the applicant(s) should be understood to have support to claim and make a statement of invention to at least: xv) processes performed with the aid of or on a computer, machine, or computing machine as described throughout the above discussion, xvi) a programmable apparatus as described throughout the above discussion, xvii) a computer-readable memory encoded with data to direct a computer comprising means or elements which function as described throughout the above discussion, xviii) a computer, machine, or computing machine configured as herein disclosed and described, xix) individual or combined subroutines and programs as herein disclosed and described, xx) a carrier medium carrying computer-readable code for control of a computer to carry out separately each and every individual and combined method described herein or in any claim, xxi) a computer program to perform separately each and every individual and combined method disclosed, xxii) a computer program containing all and each combination of means for performing each and every individual and combined step disclosed, xxiii) a storage medium storing each computer program disclosed, xxiv) a signal carrying a computer program disclosed, xxv) a processor executing instructions that act to achieve the steps and activities detailed, xxvi) circuitry configurations (including configurations of transistors, gates, and the like) that act to sequence and/or cause actions as detailed, xxvii) computer-readable medium(s) storing instructions to execute the steps and cause activities detailed, xxviii) the related methods disclosed and described, xxix) similar, equivalent, and even implicit variations of each of these systems and methods, xxx) those alternative designs which accomplish each of the functions shown as are disclosed and described, xxxi) those alternative designs and methods which accomplish each of the functions shown as are implicit to accomplish that which is disclosed and described, xxxii) each feature, component, and step shown as separate and independent inventions, and xxxiii) the various combinations of each of the above and of any aspect, all without limiting other aspects in addition.

In addition, the applicant(s) should be understood to have support to claim and make a statement of the invention that may include claims directed to:
determining desired or optimal plant cultivation
determining desired or optimal plant transplanting
determining desired or optimal plant storage
providing desired plant cultivation
providing desired plant transplanting
providing desired plant storage
systems to achieve desired plant cultivation
systems to achieve desired plant transplanting
systems to achieve desired plant storage
a plant transplanting device
a plant cultivation device
a plant storage device
specific configurations of plant cultivation devices
specific configurations of plant transplanting devices
specific configurations of plant storage devices
components or structures for a desired plant cultivation device
components or structures for a desired plant transplanting device
components or structures for a desired plant storage device
systems that enable a manufacturer or other user to customize plant cultivation
systems that enable a manufacturer or other user to customize plant transplanting
systems that enable a manufacturer or other user to customize plant storage devices
specific configurations of high cell density donor trays
specific configurations of efficient donor trays
specific configurations of optimized donor trays
systems that enable efficient replacement with a donor
systems that enable optimized replacement with a donor
systems that enable efficient root ball size donor transplant
components or structures for the desired root ball based transplant device
systems of efficient donor transplant economics
system to efficiently transplant uneven metric donor aspects
components or structures for a desired uneven metric donor devices
system to efficiently meet customer fulfillment
components or structures to efficiently meet customer fulfillment
specific configurations to efficiently meet customer fulfillment
systems to metrically control efficient plant donation
systems to utilize complex ratios in efficient plant donation
components or structures to utilize complex ratios in efficient plant donation
systems to efficiently optimize donor punching
components or structures to efficiently optimize donor punching

With regard to claims whether now or later presented for examination, it should be understood that for practical reasons and so as to avoid great expansion of the examination burden, the applicant may at any time present only initial claims or perhaps only initial claims with only initial dependencies. The office and any third persons interested in potential scope of this or subsequent applications should understand that broader claims may be presented at a later date in this case, in a case claiming the benefit of this case, or in any continuation in spite of any preliminary amendments, other amendments, claim language, or arguments presented, thus throughout the pendency of any case there is no intention to disclaim or surrender any potential subject matter. It should be understood that if or when broader claims are presented, such may require that any relevant prior art that may have been considered at any prior time may need to be revisited since it is possible that to the extent any amendments, claim language, or arguments presented in this or any subsequent application are considered as made to avoid such prior art, such reasons may be eliminated by later presented claims or the like. Both the examiner and any person otherwise interested in existing or later potential coverage, or considering if there has at any time been any possibility of an indication of disclaimer or surrender of potential coverage, should be aware that no such surrender or disclaimer is ever intended or ever exists in this or any subsequent application. Limitations such as arose in Hakim v. Cannon Avent Group, PLC, 479 F.3d 1313 (Fed. Cir 2007), or the like are expressly not intended in this or any subsequent related matter. In addition, support should be understood to exist to the degree required under new matter laws—including but not limited to European Patent Convention Article 123(2) and United States Patent Law 35 USC 132 or other such laws—to permit the addition of any of the various dependencies or other elements presented under one independent claim or concept as dependencies or elements under any other independent claim or concept. In drafting any claims at any time whether in this application or in any subsequent application, it should also be understood that the applicant has intended to capture as full and broad a scope of coverage as legally available. To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, if or when used, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps but not the exclusion of any other element or step or group of elements or steps. Such terms should be interpreted in their most expansive form so as to afford the applicant the broadest coverage legally permissible. The use of the phrase, “or any other claim” is used to provide support for any claim to be dependent on any other claim, such as another dependent claim, another independent claim, a previously listed claim, a subsequently listed claim, and the like. As one clarifying example, if a claim were dependent “on claim 20 or any other claim” or the like, it could be re-drafted as dependent on claim 1, claim 15, or even claim 25 (if such were to exist) if desired and still fall with the disclosure. It should be understood that this phrase also provides support for any combination of elements in the claims and even incorporates any desired proper antecedent basis for certain claim combinations such as with combinations of method, apparatus, process, and the like claims.

Finally, any claims set forth at any time are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

1. A method of cultivating plants for efficient order fulfillment comprising the steps of:
utilizing prior propagule growth information to quantitatively develop multi-cycle horticultural growth relationships;
developing at least one multi-cycle replacement tray maximization metric;
programming said multi-cycle replacement tray maximization metric for automated operation by a programmable plant growth configured computer system;
determining the multi-cycle future propagule order fulfillment requirement;
inputting said multi-cycle future propagule order fulfillment requirement into said multi-cycle replacement tray maximization metric for automated operation in said programmable plant growth configured computer system;
primarily growing a first cycle customer tray having a plurality of propagules as automatically provided for a program implemented to utilize said at least one multi-cycle replacement tray maximization metric in said programmable plant growth configured computer system;
at least part simultaneously differentially growing a multi-cycle replacement tray based on said multi-cycle future propagule order fulfillment requirement and said at least one multi-cycle replacement tray maximization metric as automatically indicated by said program to optimize multi-cycle replacement tray maximization metric in said programmable plant growth configured computer system;
first programmable plant growth configured computer system accepting a valid replacement need;
first indicating a transplant on said programmable plant growth configured computer system as a result of said step of automatically providing for a program implemented to utilize said at least one multi-cycle replacement tray maximization metric in said programmable plant growth configured computer system
transplanting a multi-cycle replacement tray propagule from said multi-cycle replacement tray to replace a defective first cycle customer tray propagule in said first cycle customer tray through use of an automated propagule punch system;
primarily growing a second cycle customer tray having a plurality of second cycle customer tray propagules as automatically provided for a program implemented to utilize said at least one multi-cycle replacement tray maximization metric in said programmable plant growth configured computer system;
second programmable plant growth configured computer system accepting a valid replacement need;
second indicating a transplant on said programmable plant growth configured computer system as a result of said step of automatically providing for a program implemented to utilize said at least one multi-cycle replacement tray maximization metric in said programmable plant growth configured computer system; and
transplanting a multi-cycle replacement tray propagule from said multi-cycle replacement tray to replace a defective second cycle customer tray propagule through use of said automated propagule punch system.

2. A method of cultivating plants for efficient order fulfillment as described in claim 1 wherein at least part simultaneously differentially growing a multi-cycle replacement tray based on said multi-cycle future propagule order fulfillment requirement and said at least one multi-cycle replacement tray maximization metric comprises secondarily differentially growing a multi-cycle replacement tray based on said multi-cycle future propagule order fulfillment requirement.

3. A method of cultivating plants for efficient order fulfillment as described in claim 1 wherein said multi-cycle replacement tray comprises a higher cell density multi-cycle replacement tray than said first cycle customer tray, having a first cycle customer tray cell density.

4. A method of cultivating plants for efficient order fulfillment as described in claim 1 wherein said multi-cycle replacement tray comprises a multi-cycle replacement tray cell density at least three times that of said first cycle customer tray, having a first cycle customer tray cell density.

5. A method of cultivating plants for efficient order fulfillment as described in claim 1 wherein said multi-cycle replacement tray comprises a higher cell density multi-cycle replacement tray than said second cycle customer tray, having a second cycle customer tray cell density cell density.

6. A method of cultivating plants for efficient order fulfillment as described in claim 1 wherein said multi-cycle replacement tray comprises a multi-cycle replacement tray cell density at least three times that of said second cycle customer tray, having a second cycle customer tray cell density cell density.

7. A method of cultivating plants for efficient order fulfillment as described in claim 1 wherein transplanting a multi-cycle replacement tray propagule from said multi-cycle replacement tray to replace a defective first cycle customer tray propagule in said first cycle customer tray through use of an automated propagule punch system comprises automatically replacing at least one replacement tray propagule with an automated propagule punch system.

8. A method of cultivating plants for efficient order fulfillment as described in claim 7 wherein said automated plant punching system comprises an artificially intelligent plant punching system.

9. A method of cultivating plants for efficient order fulfillment as described in claim 1 wherein said at least one multi-cycle replacement tray maximization metric comprises a future projection of transplant propagule need metric.

10. A method of cultivating plants for efficient order fulfillment as described in claim 10 wherein said future projection of transplant propagule need comprises a 100 percent customer order fulfillment metric.

11. A method of cultivating plants for efficient order fulfillment comprising the steps of:
utilizing prior propagule growth information to quantitatively develop multi-cycle horticultural growth relationships;
determining at least one multi growth stage parameterized metric;
programming said multi growth stage parameterized metric for automated operation by a programmable plant growth configured computer system;
utilizing said at least one multi growth stage parameterized metric to configure a reduced replacement metrically controlled process to replace a customer tray propagule;
calculating a reduced replacement parameter based on a future customer tray propagule need; and
inputting said at least one multi growth stage parameterized metric into said reduced replacement metrically controlled process for automated operation in said programmable plant growth configured computer system;
replacing at least one customer tray propagule with an automated plant punching system;
utilizing said reduced replacement parameter to maximally fulfill said future customer tray propagule need.

12. A method of cultivating plants for efficient order fulfillment as described in claim 11 further comprising compositely calculating said reduced replacement parameter with said at least one yield maximization metric.

13. A method of cultivating plants for efficient order fulfillment as described in claim 11 wherein said metrically controlled process comprises operator visual detection.

14. A method of cultivating plants for efficient order fulfillment as described in claim 11 wherein said metrically controlled process comprises computer detection.

15. A method of cultivating plants for efficient order fulfillment as described in claim 11 wherein said multi growth stage parameterized metric comprises a weekly demand metric.

16. A method of cultivating plants for efficient order fulfillment as described in claim 11 wherein said multi growth stage parameterized metric comprises a germination rate of customer tray metric.

17. A method of cultivating plants for efficient order fulfillment as described in claim 11 wherein said multi growth stage parameterized metric comprises a germination rate of donor tray metric.

18. A method of cultivating plants for efficient order fulfillment as described in claim 11 wherein said multi growth stage parameterized metric comprises a number of plants in inventory metric.

19. A method of cultivating plants for efficient order fulfillment comprising the steps of:
utilizing prior propagule growth information to quantitatively develop multi-cycle horticultural growth relationships;
determining a multi growth stage parameterized metric;
programming said multi growth stage parameterized metric for automated operation by a programmable plant growth configured computer system;
utilizing said multi growth stage parameterized metric to configure metrically controlled processes to optimize order fulfillment production yield;
inputting said at least one multi growth stage parameterized metric into said reduced replacement metrically controlled process to optimize order fulfillment production yield for automated operation in said programmable plant growth configured computer system;
replacing at least one customer tray propagule with an automated plant punching system; and
achieving a metrically optimized order fulfillment production yield which is statistically optimized as compared to a traditional transplant production yield.

20. A method of cultivating plants for efficient order fulfillment as described in claim 19 wherein achieving a metrically optimized order fulfillment production yield comprises at least 90 percent order fulfillment.

21. A method of cultivating plants for efficient order fulfillment as described in claim 19 wherein achieving a metrically optimized order fulfillment production yield comprises at least 95 percent order fulfillment.

22. A method of cultivating plants for efficient order fulfillment as described in claim 19 wherein utilizing said multi growth stage parameterized metric to configure metrically controlled processes to optimize order fulfillment production yield comprises optimizing transplant propagule waste.

23. A method of cultivating plants for efficient order fulfillment as described in claim 19 wherein achieving a metrically optimized order fulfillment production yield comprises 100 percent order fulfillment.

24. A method of cultivating plants for efficient order fulfillment as described in claim 19 wherein achieving a metrically optimized order fulfillment production yield which is statistically optimized as compared to a traditional transplant production yield comprises optimizing a transplant propagule yield to customer propagule ratio.

25. An automated, computer implemented efficient plant order fulfillment system comprising:
a programmable plant growth configured computer system;
at least one computer stored, multi-cycle replacement tray maximization metric program stored in said programmable plant growth configured computer system, wherein said at least one computer stored, multi-cycle replacement tray maximization metric program includes parameters based on prior propagule growth information, and includes quantitative plant multi-growth stage parameterized horticultural growth relationships;
a multi-cycle future propagule order fulfillment requirement input for said programmable plant growth configured computer system, and that interfaces with said at least one computer stored, multi-cycle replacement tray maximization metric program;
a first cycle customer tray having a plurality of propagules;
a first cycle customer tray primary growth environment control having an operator interface with said programmable plant growth configured computer system;
a first cycle customer primary growth environment configured to influence said first cycle customer tray, and to operate as automatically provided for a program implemented to utilize said at least one multi-cycle replacement tray maximization metric in said programmable plant growth configured computer system;
a multi-cycle replacement tray having a plurality of donor propagules;
an at least partly simultaneous, differential donor growth environment control having an operator interface with said programmable plant growth configured computer system;
a donor growth environment configured to operate as automatically provided for a program implemented to utilize said at least one multi-cycle replacement tray maximization metric in said programmable plant growth configured computer system;
a first cycle customer tray automated propagule punch system;
a second cycle customer tray having a plurality of propagules;
a second cycle customer tray primary growth environment control having an operator interface with said programmable plant growth configured computer system;
a second cycle customer primary growth environment configured to influence said second cycle customer tray, and to operate as automatically provided for a program implemented to utilize said at least one multi-cycle replacement tray maximization metric in said programmable plant growth configured computer system; and
a second cycle customer tray automated propagule punch system.

26. An automated, computer implemented efficient plant order fulfillment system as described in claim 25, further comprising:
a first replacement need acceptance subroutine stored in said programmable plant growth configured computer system;
a first transplant indicator stored in said programmable plant growth configured computer system;
a second replacement need acceptance subroutine stored in said programmable plant growth configured computer system; and
a second transplant indicator stored in said programmable plant growth configured computer system.
